(19) United States
(12) Patent Application Publication
(10) Pub. No.: US 2012/0078662 A1
(43) Pub. Date: Mar. 29, 2012

(54) DEVICE, SYSTEM AND METHOD FOR ELECTRONICALLY FILLING OUT AN EMERGENCY MEDICAL SERVICES REPORT FORM

(76) Inventor: Ricky Olivarez, Diamond Bar, CA (US)

(21) Appl. No.: 13/190,361

(22) Filed: Jul. 25, 2011

Related U.S. Application Data
(60) Provisional application No. 61/386,171, filed on Sep. 24, 2010.
(60) Provisional application No. 61/405,564, filed on Oct. 21, 2010.

(51) Int. Cl. G06Q 50/00

(52) U.S. Cl. 705/3

(57) ABSTRACT

This invention is a device, system, and method for digitally filling out, completing, and transmitting an emergency medical services report form. The computerized emergency medical services report form is designed to mimic the emergency medical services report form that the user is already accustomed to completing during an incident. The user completes the digital form by entering the incident data into the form via a touch screen or keyboard. Because the digital form is essentially identical to the paper form, the users do not require a significant amount of additional training on how to fill out the digital form.

### CROSS REFERENCE TO RELATED APPLICATIONS

Priority is claimed to U.S. Provisional Application Ser. No. 61/386,171 filed on Sep. 24, 2010, titled “APPLICATION THAT USES AN EXISTING EMS FORM IN WHICH PARAMEDICS ARE USED TO, ALLOWING EMS PERSONAL TO USE DURING AN EMERGENCY SITUATION WHILE STILL FULFILLING NEMSIS/CEMSIS REQUIREMENTS. THE APPLICATION WILL BE MADE FIRST FOR THE APPLE® IPAD®, AND POSSIBLY FOR FUTURE HARDWARE DEVICES”, by inventor Ricardo Olivarez, the contents of which are expressly incorporated herein by this reference. Priority is also claimed to U.S. Non-Provisional Patent Application No. 13/084,474, filed on Apr. 11, 2011, titled “COMPUTER-BASED METHOD OF GENERATING A UNIQUE NON-REPEATING SEQUENCE NUMBER,” by inventor Ricardo Olivarez, the contents of which are expressly incorporated herein by this reference. Priority is also claimed to U.S. Provisional Patent Application No. 61/405,564, filed on Oct. 21, 2010, titled, “A METHOD FOR THE CREATION OF A SEQUENCE NUMBER THAT IS INDEPENDENT OF THE EMS PROVIDER USING IT, AND NEVER REPEATS,” by inventor Ricardo Olivarez, the contents of which are expressly incorporated herein by this reference.

### FIELD OF INVENTION

This invention relates, generally, to devices, systems, and methods for filling out and completing electronic forms. More particularly, the invention presents a digital image of an incident report form, commonly referred to as an “EMS Report Form,” and allows the user to fill out and complete the EMS Report form digitally. The user is typically a first responder or an Emergency Medical Services (hereinafter “EMS”) responder or unit. The EMS unit personnel fill out the EMS Report Form as a first, or subsequent, responder to an emergency incident. The invention displays a plurality of digital images of an incident report form, or EMS Report Form, which allows the user to interact with, fill out, and complete the form digitally. The EMS user may interact with the system by touching the screen or typing information into the digital fields. Because the digital fields and images are based upon the currently used EMS Report Form, which EMS personnel routinely complete, the users can immediately start to use the electronic form device without substantial training.

### BACKGROUND

The recent improvements in information technology and computer-based communications have allowed widespread advances in methods and systems for emergency medical response. Inventors have attempted to modernize the process by creating entirely new medical records systems to capture patient data. For example, U.S. Pat. No. 5,924,074, issued to Evans, and U.S. Patent Published Application Nos. 10/969,810, filed by Aga De Zwart, and 12/351,620, filed by Gedeon, are three such systems. The Evans reference discloses a point-of-care system to capture and store patient data at each step of the care process, including clinical data, diagnoses, procedures administered to the patient, and progress notes. The data is then stored in a patient data repository. The Aga De Zwart reference discloses a computer-based system that determines whether the user is holding the electronic device in his left or right hand while they input the medical information. The Gedeon reference discloses an electronic device that collects additional user data from a pre-populated form with one or more existing data.

While the above systems disclose means for user computer based programs to collect medical information, none of the above systems are directed towards a computer based system for computerizing existing forms that are familiar to EMS personnel. Accordingly, those three references require a complete change over from the reporting system that is currently being done, which, in turn, requires countless hours of training for any medical professional that will use the systems. When a new information technology records system is put in place, the personnel that are responsible for using the new and/or improved systems must attend additional training to learn the new systems. The training is purely administrative and essentially duplicates the training that the personnel received when they learned the old system. Because the three above references do not disclose systems for computerizing the old, paper-based EMS Report Forms, this system remains in place besides the systems disclosed in Evans, Aga De Zwart, and Gedeon.

Regarding the current EMS Report Form system, it was created in the late 1990s and has been revised several times since that time. The EMS Report Form itself is a staple in many county and state emergency medical services systems. With few exceptions, the EMS Report form must be completed for every emergency response. The EMS Report Form is a paper document that provides fields for the EMS personnel to write complete information about the patient and incident in order to comply with municipal, county, and state health requirements.

One of the goals of the EMS Report Form is to provide justification for services rendered and create documentation for future medical costs or legal consequences. Additionally, once completed, the information on the Form assists several groups of people that are involved in the overall care of the patient as s/he makes his/her way through health care system, including: emergency services personnel, first responders, healthcare personnel, data collection agencies, billing departments, courts, law enforcement personnel, government agencies, coroners, community health agencies, HAZMAT teams, researchers, hospitals, and other care providers. The EMS Report Form is comprised of several sections. The sections are as follows: Incident Information; Transportation, Patient Assessment; Patient Info; GCS/mLAPSS; Special Circumstances; Comments; Complaints; Physical Characteristics; Vital Signs; Therapies; ALS Procedures; Team Member IDs; Cardiac Arrest; and Reassessment after Therapies. Typically, the back side of each duplicate of the form has additional information for successful completing the form. Although the EMS Report Form system has been very successful in tracking treatment given to the patient as s/he moves through the medical system from first response to treatment at a hospital or other medical facility, this system is not digital and the information written in the Form must ultimately be transcribed into the various digital health care information systems

Thus, there remains a long felt need in the art for a device and computer-based system and/or method of filing out an EMS Report Form without requiring the user to spend significant time learning how to use the invention.

### SUMMARY OF THE INVENTION

To minimize the limitations in the prior art, and to minimize other limitations that will become apparent upon reading and understanding the present specification, the present invention relates to a computer or electronic data processing unit based device, method, and, system for filling out an electronic EMS Report Form. The digital EMS Report Form invention allows the user to easily transfer the inputted data quickly and completely to a variety of connected hospital and billing systems without the need to retype or rewrite the data. By mimicking the format of the paper EMS Report Form and placing the digital form on a portable, touch-screen computer, EMS personnel can easily fill out the incident report form in stressful situations, capture the necessary data elements on the form that comply with municipal and state health requirements, and transfer the data quickly and completely to primary care provides to ensure the best possible patient care.

The invention is a simplified user interface to complete the incident report form that allows EMS personnel to populate fields of the form without restricting the navigation options, as if the first responder was filling out the form on paper. To encourage adaptation of the system, the system may display a plurality of digital images of an EMS Report Form because EMS professionals are accustomed to using the form. The user may interact with the system by touching the screen, selecting fields with a tool, or typing information into the digital fields. Depending upon the jurisdiction of the user of the digital form, the digital form would be made to mimic that users jurisdictional form. In this manner, no matter where in the United States the user was, the digital emergency medical services form would mimic that users paper form.

Because the digital images tray be based upon paper documents that EMS personnel routinely complete, the EMS personnel can use the electronic form without substantial training. When the form is complete, the system provides internet connectivity to send the Form to the hospital that treats the patient.

By mimicking the format of the paper Form and placing the digital form on a portable, touch-screen computer, EMS personnel will have a shallow learning curve and be able to fill out the form with little instruction on how to use the software. Also, EMS personnel can fill out federally required paperwork under stressful situations to allow for better patient care without delay, while still being able to capture the necessary data elements to comply with local department of health services and state requirements.

One embodiment of the invention is a computer-based method for filling out an emergency medical services report form comprising the steps: providing an electronic data processing unit; wherein the electronic data processing unit is comprised of a display; displaying on the display of the electronic data processing unit a digital emergency medical services report form; wherein the digital emergency medical services report form is comprised of a plurality of sections, including at least a first section and a second section; wherein each of the sections is comprised of a plurality of report data fields; responding to a medical emergency incident of a patient by an emergency response unit; inputting a plurality of incident data into the plurality of report data fields by the emergency response unit; wherein the digital emergency medical services report form is substantially the same as an existing paper emergency services report form used by the emergency response unit. Preferably the steps of the method also include using the electronic data processing unit to select between displaying a new digital emergency medical services report form, a previously completed digital emergency medical services report form, and an unfinished digital emergency medical services report form. The steps of the method may also include: generating by the electronic data processing unit a unique emergency medical services report number; and assigning by the electronic data processing unit the unique emergency medical services report number to the new digital emergency medical services report form for the patient. The unique emergency medical services report number is preferably unique to the new digital emergency medical services report form. The unique emergency medical services report number is preferably a sequence of alphanumeric characters that is a combination of a plurality of identification codes. The identification codes are typically selected from the group consisting of: a provider code; a numeric date code; a year code; a unit number; and a unit code. The method preferably includes the steps of: selecting the first section to input the plurality of incident data; generating and displaying by the electronic data processing unit a first section form, wherein the first section form displays a plurality of first section report data fields, and wherein the plurality of first section report data fields correspond with the plurality of report data fields of the first section; inputting the plurality of incident data into the plurality of first section report data fields by the emergency response unit; populating, by the electronic data processing unit, the incident data inputted into the first section form into the plurality report data fields of the selected first section; selecting the second section to input the plurality of incident data; generating and displaying by the electronic data processing unit a second section form, wherein the second section form displays a plurality of second section report data fields, and wherein the plurality of second section report data fields correspond with the plurality of report data fields of the second section; inputting the plurality of incident data into the plurality of second section report data fields by the emergency response unit; populating, by the electronic data processing unit, the incident data inputted into the second section form into the plurality report data fields of the selected second section. The sections might be further comprised of a signature section and the method preferably includes the steps of: selecting the signature section to input one or more signatures of one or more members of the emergency response unit that completed the new digital emergency medical services report form; and digitally inputting the one or more signatures of the one or more members of the emergency response unit that completed the new digital emergency medical services report form. Typically the new digital emergency medical services report form has a navigation menu. The navigation menu is usually displayed at a top portion of the new digital emergency medical services report form. The method may also include the steps of: providing one or more supplemental digital emergency medical services report forms; wherein the one or more supplemental digital emergency medical services report forms are accessed through the navigation menu; wherein the one or more supplemental digital emergency medical services report forms are selected from the group consisting of: a digital supplemental continuation form; a digital Medicare® form; and a digital against medical advice form; wherein the one or more supplemental digital emergency medical services report forms each have a plurality of supplemental data fields; inputting a plurality of supplemental incident data into the plurality of supplemental data fields by the emergency response unit; wherein the navigation menu is further comprised of options selected from the group consisting of: information; supplemental forms; a transmit; and finish report button; selecting by the emergency response unit the information option; displaying by the electronic data processing unit an information screen; wherein the information screen provides a plurality of links to information selected from the group consisting of: medication; treatment guidelines; medical control guidelines; and municipal policies; completing the new digital emergency medical services report form; and transmitting the completed emergency medical services report form to one or more medical facilities that receive the patient after the patient is released by the emergency response unit.

In another embodiment of the invention the sections are comprised of the following sections: Incident Information; Transportation, Patient Assessment; Patient Info; GCS/mLAPSS; Special Circumstances; Comments; Complaints; Physical Characteristics; Vital Signs; Therapies; ALS Procedures; Team Member IDs; Cardiac Arrest; Reassessment after Therapies; and a signature section.

Another embodiment of the invention is a device for filling out a digital emergency medical services report form, comprising: an electronic processing unit; wherein the electronic processing unit has a display; wherein the electronic processing unit is portable; wherein the electronic processing unit displays a digital emergency medical services report form; wherein the digital emergency medical services report form is comprised of a plurality of sections, including at least a first section and a second section; wherein each of the sections is comprised of a plurality of report data fields; wherein the digital emergency medical services report form is substantially identical to an existing paper emergency services report form used by an emergency response unit; wherein the emergency response unit responds to a medical emergency incident of a patient; wherein the emergency response unit inputs a plurality of incident data into the plurality of report data fields. Preferably the electronic processing unit of the device has a touch screen; wherein the plurality of incident data is input into the plurality of report data fields through the touch screen; wherein the electronic data processing unit generates a unique emergency medical services report number; wherein the electronic data processing unit assigns the unique emergency medical services report number to the digital emergency medical services report form for the patient; wherein the unique emergency medical services report number is unique to the new digital emergency medical services report form; wherein the unique emergency medical services report number is a sequence of alphanumeric characters that is a combination of a plurality of identification codes; wherein the plurality of identification codes are selected from the group consisting of: a provider code; a numeric date code; a year code; a unit number; and a unit code. The device is preferably able to accept digital electronic signatures in a signature section of the plurality of sections. When signed and completed, the user typically transmits the form or the contents of the form to one or more medical facilities that receive the patient after the patient is released by the emergency response unit.

Another embodiment of the invention comprises a computer-based system for filling out an incident report form that may comprise: a system for the collection of a user's answers and responses to a series of questions and prompts; a system for the production of an incident report, the incident report being produced based upon the user's answers and responses to the series of questions and prompts and the incident report containing classifications of information to include in the incident report; the one or more classifications being related to one or more of the following: patient assessment, therapies, transportation of a patient, patient information, comments, patient's complaints, patient's physical attributes, vital signs, medications, or other such information; and an electronic device for providing information about the user's classifications to one or more other users that use the incident report. The system may further comprise a means for collecting signatures from a patient or user. Additionally, the system may further comprise a means for the user to access received or currently unfinished incident reports that are filled with questions and answers. Preferably, the system further comprises a means for the user to store received or currently unfinished incident reports that are filled with questions and answers. The system further may further an informational library. The informational library may comprise information pertaining to the classifications of providers, types of units that respond to incidents, and Glasgow Coma Scale values for eyes, motor, and verbal indicators. The system may further comprise internet connectivity to transfer the incident report to individuals outside of the system. The incident report may contain one or more images of a digitized EMS Report Form.

Another embodiment of the invention comprises a computer-based method for filling out an incident report form, that may comprise the following steps: administering an incident assessment on users, the incident assessment comprising a user's answers and responses to a series of questions and prompts; producing an incident report form, the incident report form being produced based upon the user's answers and responses to the series of questions and prompts and the incident report form containing fillable fields related to one or more classifications; the one or more classifications being related to one or more of the following: patient assessment, therapies, transportation of a patient, patient information, comments, patient's complaints, patient's physical attributes, vital signs, medications, or other such information; and providing an electronic device for providing information about the user's classifications to one or more other users that use the incident report form. The method may further comprise signing the incident report form by a patient or user. Preferably, the method for filling out an incident report form further comprises accessing received or currently unfinished incident reports. The method may further comprise storing received or currently unfinished incident reports that are filled with questions and answers. The method may further comprise the users accessing an informational library. The informational library may include information pertaining to the classifications of providers, types of units that respond to incidents, and Glasgow Coma Scale values for eyes, motor, and verbal indicators. The method may further comprise connecting to the internet to transfer the incident report to individuals outside of the system. The incident report may include one or more images of a digitized EMS Report Form.

An object of the invention is directed towards overcoming the above shortcomings by disclosing a computer-based system for completing the EMS Report Form, which improves upon the above Referenced systems by providing a digital document of a standard paper form that EMS personnel are already trained to use. Like the paper form and unlike the cited references, EMS personnel can navigate through the invention at-will, much like the EMS personnel would navigate through a paper form. Thus, the invention fulfills a long-felt need in the art by providing users with computer-based form to quickly and efficiently fill out an incident report, like the EMS Report Form, send the form to hospital personnel, and save a significant amount of time that would otherwise be spent on training EMS personnel to use a new system.

Another object of the invention is to simplify the method of filling out an incident report form during an emergency. The method allows the user to navigate through screens in the system as if the user was filling out the form on paper. The system provides a simplified user interface to complete the form and internet connectivity to send the form to third parties, namely hospitals. By mimicking the format of a paper form and placing the digital form on a portable, touch-screen computer, EMS personnel will have a shallow learning curve and be able to till out the form with little instruction on how to use the software. Also, EMS personnel can more easily fill out federally required paperwork under stressful situations. By minimizing the learning curve, patients may receive better care without delay, and users or hospitals may capture the necessary data elements to comply with local department of health services and state requirements.

Another object of the invention is to provide a simplified reporting device for EMS professionals so that they can fill out an incident report form in stressful situations, capture the necessary data elements on the form at comply with municipal and state health requirements, and send the form quickly to provide better patient care without delay.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a screen shot of a display of an electronic processing unit and shows the launch icon of one embodiment of the digital emergency medical services report form.

FIG. 2 is a screen shot of a display of an electronic processing unit and shows the home screen of one embodiment of the digital emergency medical services report form.

FIG. 3 is a screen shot of a display of an electronic processing unit and shows the settings screen of one embodiment of the digital emergency medical services report form.

FIG. 4 is a screen shot of a display of an electronic processing unit and shows the Provider Dropdown Field of the settings screen of one embodiment of the digital emergency medical services report form.

FIG. 5 is a screen shot of a display of an electronic processing unit and shows the Select Unit Type of the settings screen of one embodiment of the digital emergency medical services report form.

FIG. 6 is a screen shot of a display of an electronic processing unit and shows the Enter Unit Number of the settings screen of one embodiment of the digital emergency medical services report form.

FIG. 7 is a screen shot of a display of an electronic processing unit and shows the main screen of one embodiment of the digital emergency medical services report form.

FIG. 8 is a screen shot of a display of an electronic processing unit and shows the main screen of another embodiment of the digital emergency medical services report form.

FIG. 9 is a screen shot of a display of an electronic processing unit and shows the “Incident Info” section screen of one embodiment of the digital emergency medical services report form.

FIG. 10 is a screen shot of a display of an electronic processing unit and shows the user filing in the “Incident Info” section screen of one embodiment of the digital emergency medical services report form.

FIG. 11 is a screen shot of a display of an electronic processing unit and shows the user filing in the dispatch time in the “Incident Info” section screen of one embodiment of the digital emergency medical services report form.

FIG. 12 is a screen shot of a display of an electronic processing unit and shows the “GCS/Circumstances” section screen of one embodiment of the digital emergency medical services report form.

FIG. 13 is a screen shot of a display of an electronic processing unit and shows the user filing in the “GCS/Circumstances” section screen of one embodiment of the digital emergency medical services report form.

FIG. 14 is a screen shot of a display of an electronic processing unit and shows the user continuing to fill in the “GCS/Circumstances” section screen of one embodiment of the digital emergency medical services report form.

FIG. 15 is a screen shot of a display of an electronic processing unit and shows the “signature” section screen of one embodiment of the digital emergency medical services report form.

FIG. 16 is a screen shot of a display of an electronic processing unit and shows the user digitally signing the “signature” section screen of one embodiment of the digital emergency medical services report form.

FIG. 17 is a screen shot of a display of an electronic processing unit and shows the screen selection drop down menu on the navigation bar of one embodiment of the digital emergency medical services report form.

FIG. 18 is a screen shot of a display of an electronic processing unit and shows the “Continuation Form” screen of one embodiment of the digital emergency medical services report form.

FIG. 19 is a screen shot of a display of an electronic processing unit and shows a completed “Continuation Form” screen of one embodiment of the digital emergency medical services report form.

FIG. 20 is a screen shot of a display of an electronic processing unit and shows the “MediCare Form” screen of one embodiment of the digital emergency medical services report form.

FIG. 21 is a screen shot of a display of an electronic processing unit and shows a completed “MediCare Form” screen of one embodiment of the digital emergency medical services report form.

FIG. 22 is a screen shot of a display of an electronic processing unit and shows a completed “Against Medical Advice” screen of one embodiment of the digital emergency medical services report form.

FIG. 23 is a screen shot of a display of an electronic processing unit and shows the “Additional Info” menu screen of one embodiment of the digital emergency medical services report form.

FIG. 24 is a screen shot of a display of an electronic processing unit and shows one embodiment of a completed and signed digital emergency medical services report form.

FIG. 25 is a screen shot display of an electronic processing unit and shows the “Scratch Pad” screen of one embodiment of the digital emergency medical services report form.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “computer” or “electronic data processing unit” refers to any electronic data processing unit or device that processes information with an integrated circuit chip, including without limitation, mainframe computers, work stations, servers, desktop computers, portable computers, laptop computers, embedded computers, wireless devices including cellular phones, personal digital assistants, and portable game players, and hand-held computers. The term “internet” refers to any collection of networks using standard protocols, whether Ethernet, ATM, FDDI, WI-FI, Token ring, or any combination thereof. Device for storing data refers to RAM, flash drive, or other writable data structure that can receive data and write that data to a data storage device. The term “emergency medical services report form” refers to any form that is used by emergency medical service providers and/or responders concerning the transportation of a patient. Although this includes transportation of a patient during emergency situations, it further includes non-emergency transportation of patients. For example, transportation from a convalescent or rest home to the hospital may not be for an emergency, but the EMS providers and responders still are the ones to respond to the call and transport the patient. The use of emergency medical services report forms is not limited to emergency situations, but rather applies to the use of any forms necessary when medical service is provided outside of the confines of a hospital, medical clinic, or doctors office.

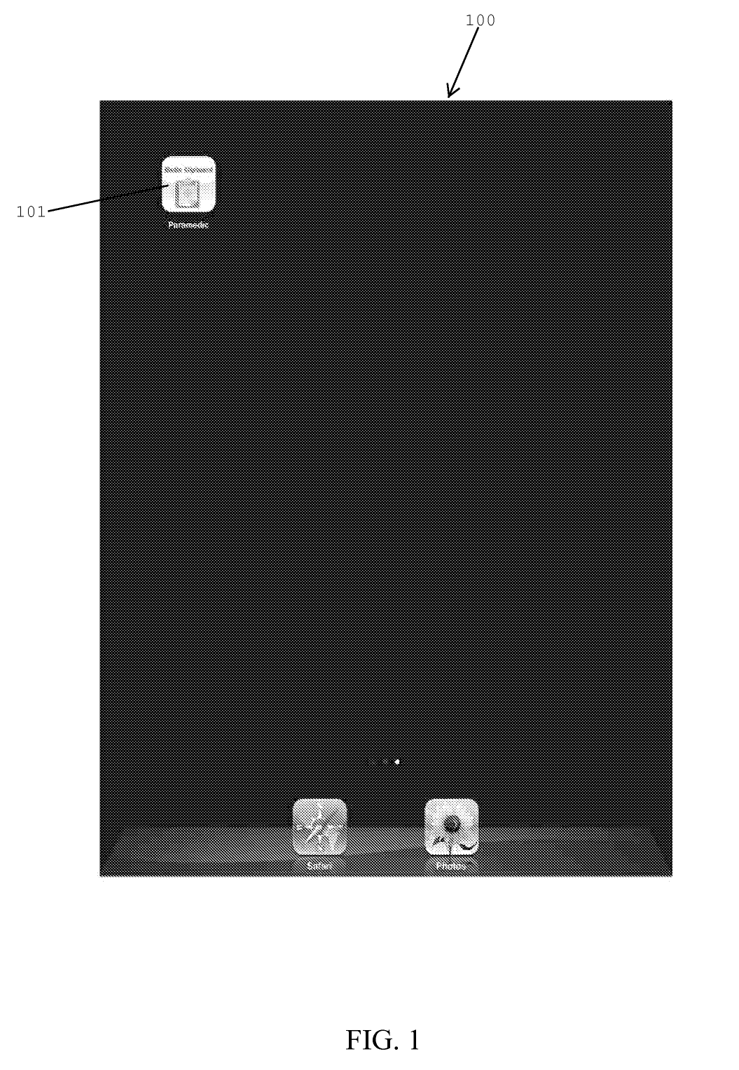

FIG. 1 is a screen shot of a display of an electronic processing unit and shows the launch icon of one embodiment of the digital emergency medical services report form. FIG. 1 shows that the display 100 is preferably part of a tablet computer, as preferred. It should be understood that the electronic processing unit may be any type of computer or computing device. The digital emergency medical services report form is launched by selecting or clicking on the launch icon 101.

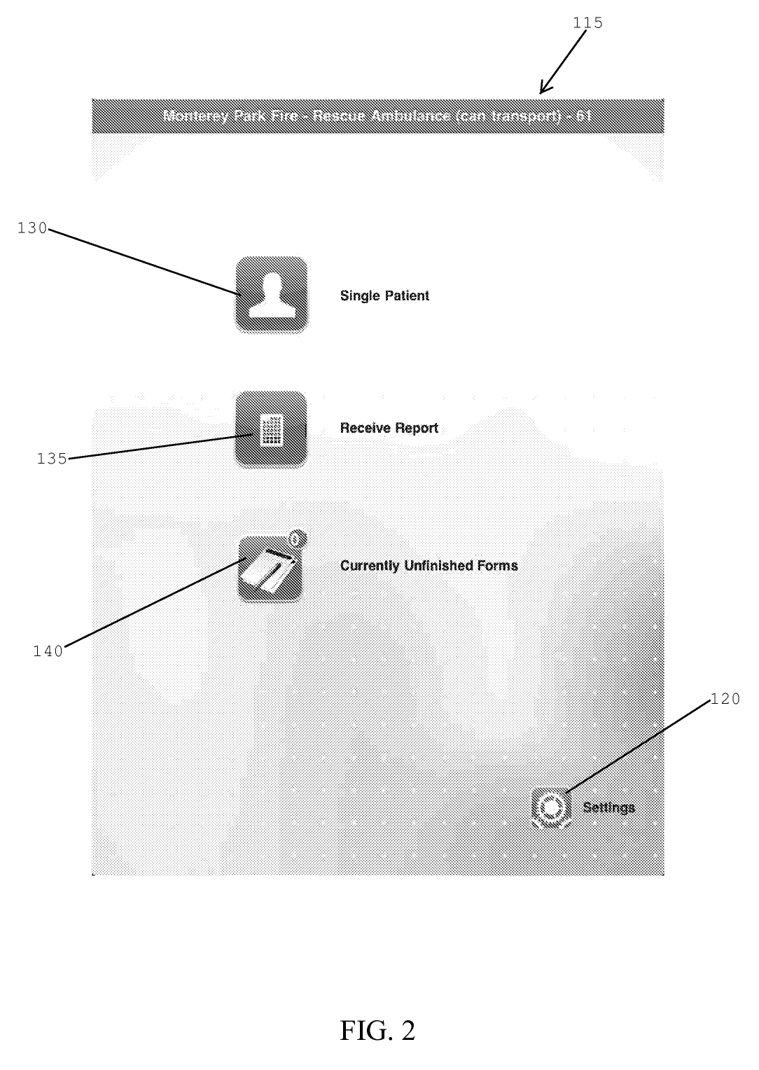

FIG. 2 is a screen shot of a display of an electronic processing unit and shows the home screen of one embodiment of the digital emergency medical services report form. FIG. 2 shows that the home screen or options screen 115 preferably includes several options, including, but not limited to Settings 120, Single Patient 130, Receive Report 135, and Currently Unfinished Forms 140. If the user has not used the device of the present invention before or needs to change the settings, the user will choose, select, or elect, Settings 120 in order to specify certain settings for the application. The settings that the user specifies will preferably pre-fill data for the user in one or more areas of the form and create a unique form number for each new form without the user's additional intervention.

Once the settings are set, the user may select the Single Patient Icon 130 to begin filling out the digital emergency medical services report form. Other options include clicking on Receive Report 135 in order to receive a digital emergency medical services report form from another source, and completing a saved but not completed form by selecting Currently Unfinished Forms 140.

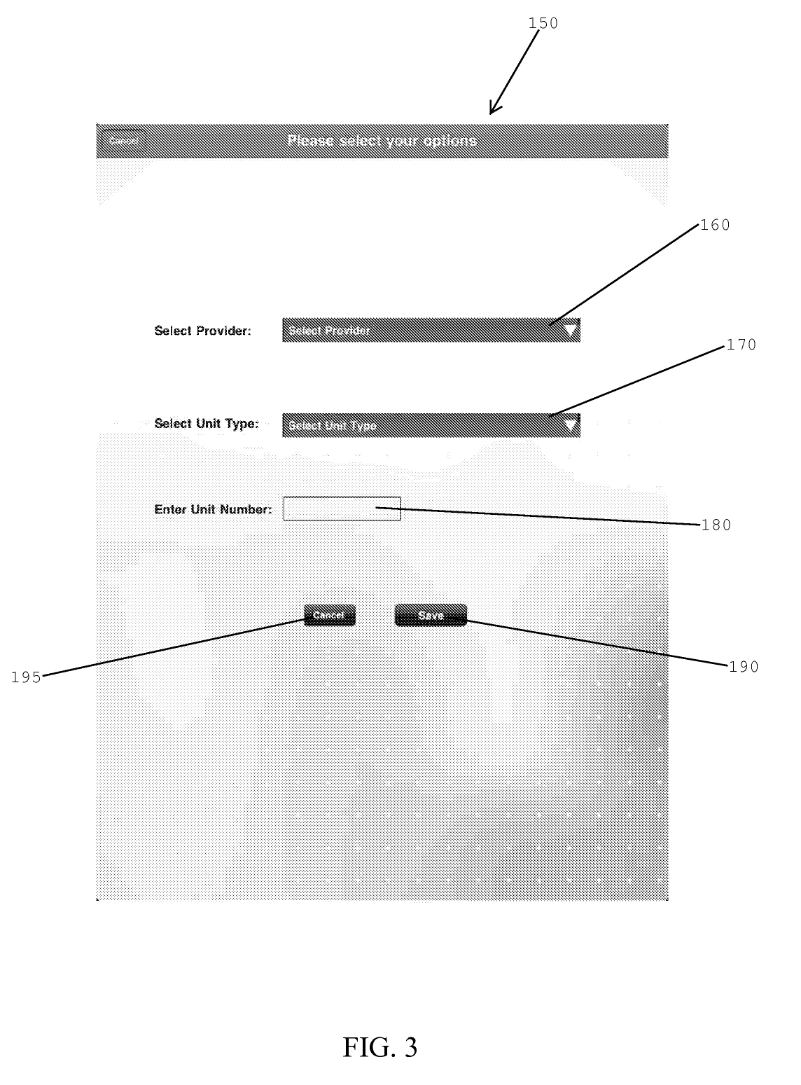

FIG. 3 is a screen shot of a display of an electronic processing unit and shows the settings screen of one embodiment of the digital emergency medical services report form. FIG. 3 shows how the Settings Screen 150 preferably includes a Select Provider 160 drop down menu, a Select Unit Type 170 drop down menu, an Enter Unit Number 180 box, a cancel 195 option, and a save 190 option.

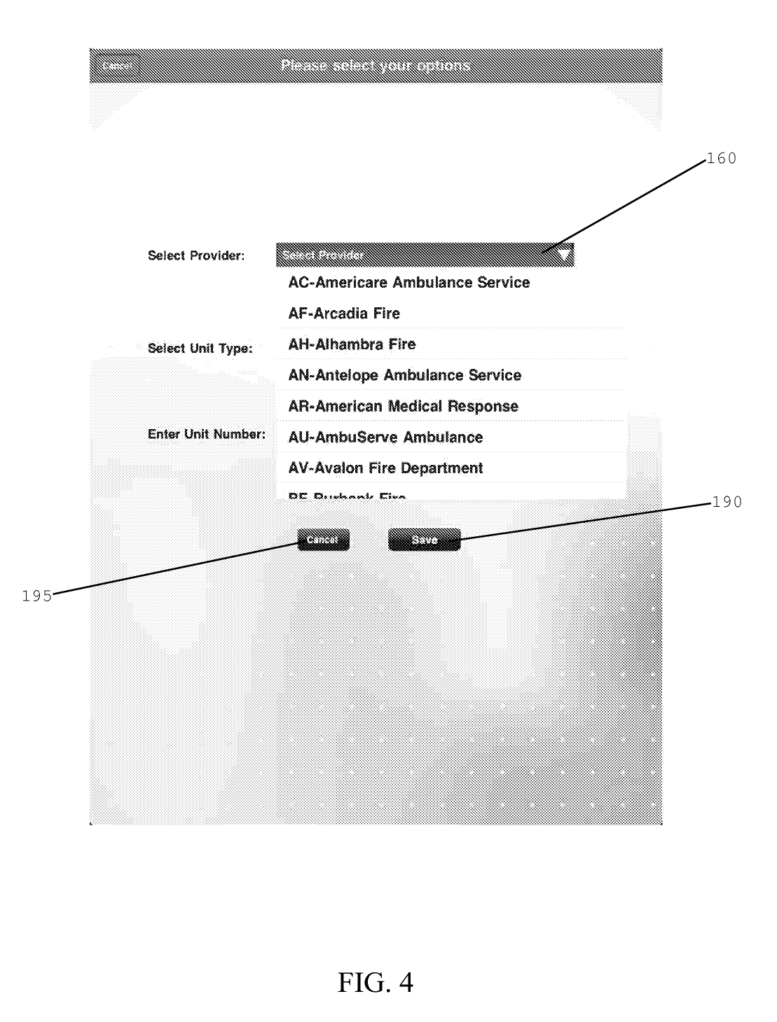

In order to fill in the settings, the user may click each dropdown field and select the appropriate information. In one embodiment, FIGS. 4, 5, and 6 disclose steps of one method to input these settings.

FIG. 4 is a screen shot of a display of an electronic processing unit and shows the Provider Dropdown Field of the settings screen of one embodiment of the digital emergency medical services report form. When the user selects the Select Provider 160 drop down menu, a list of emergency response providers, specific to a specific region, municipality, or state of the user is displayed. The user selects which provider he, she, or they are. When the user selects a provider, the selection is populated in that field. In this manner, whenever a digital emergency medical services report form is accessed on that particular electronic processing unit, the form is linked with the selected provider. Preferably, the provider code, which is typically a two digit alphanumeric code, becomes part of a unique form identifier of each new digital emergency medical services report form generated. The user saves the selection by selecting Save 190. The user can cancel the selection or exit the screen by selecting Cancel 195.

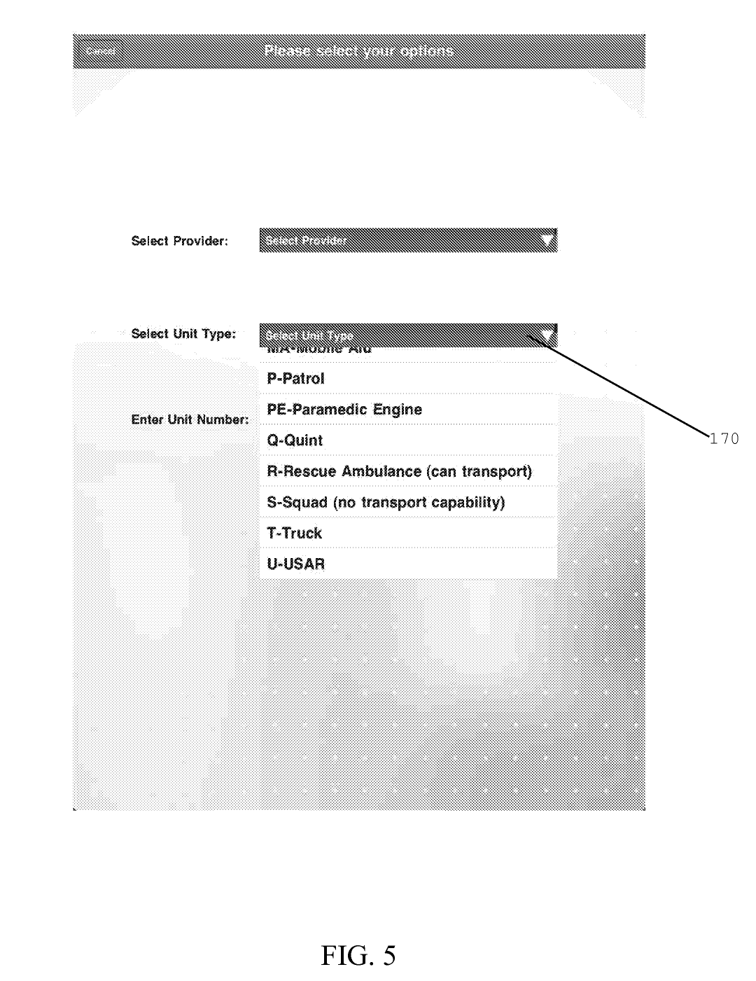

FIG. 5 is a screen shot of a display of an electronic processing unit and shows the Select Unit Type of the settings screen of one embodiment of the digital emergency medical services report form. As shown in FIG. 5, when the user clicks on or selects the Select Unit Type 170 dropdown menu, a list of unit types with a unit code are displayed for the user. Some of the unit types may include, but are not limited to: Patrol; Paramedic Engine; Quint; Rescue Ambulance; Squad; Truck; and USAR. The user selects the option that describes his or her unit type. When the user selects a unit type, the selection is populated in that field. In this manner, whenever a digital emergency medical services report form is accessed on that particular electronic processing unit, the form is linked with the selected unit type. Preferably, the unit type code, which is typically a one to two digit alphanumeric code, becomes part of a unique form identifier of each new digital emergency medical services report form generated.

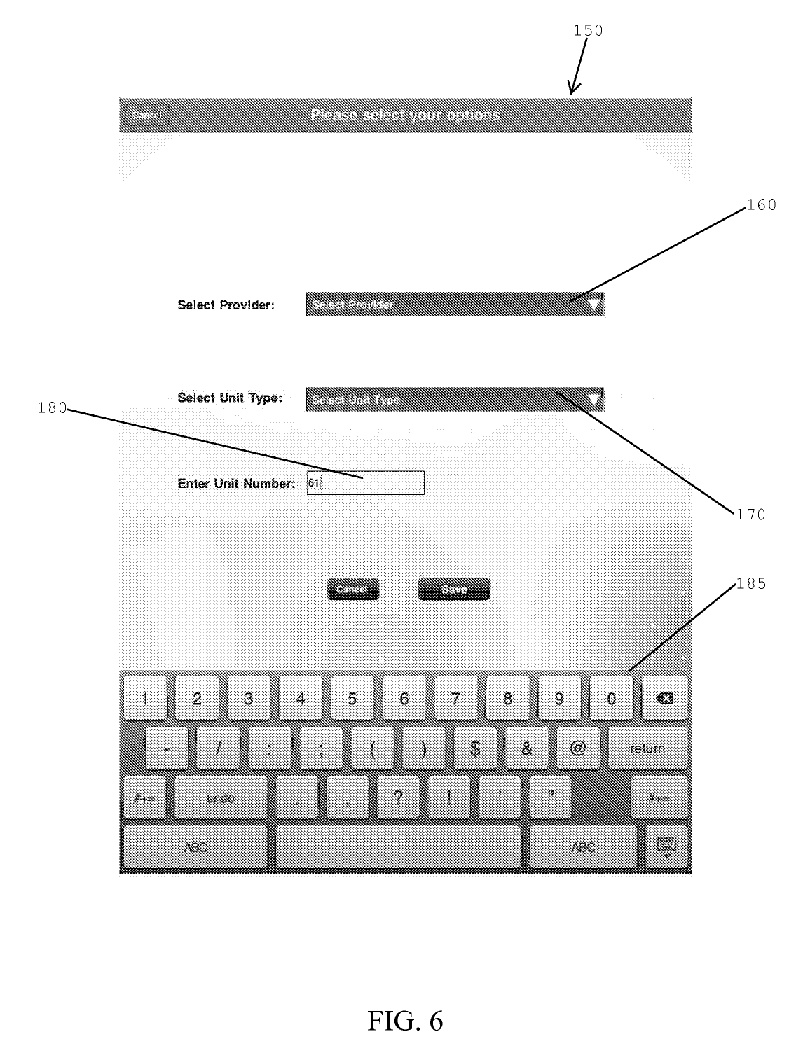

FIG. 6 is a screen shot of a display of an electronic processing unit and shows the Enter Unit Number of the settings screen of one embodiment of the digital emergency medical services report form. FIG. 6 shows that, unlike the when the user clicks the Select Provider 160 Dropdown menu or the Select Unit Type 170 Dropdown menu, when the user clicks the Enter Unit Number 180 Text Field, a touch keyboard 185 appears. The user preferably uses the keyboard to enter the appropriate unit number into the Enter Unit Number 180 Text Field. When the user enters a unit number, the entry is populated in that field. In this manner, whenever a digital emergency medical services report form is accessed on that particular electronic processing unit, the form is linked with the entered unit number. Preferably, the unit number, which is typically a two digit numeric code, becomes part of a unique form identifier of each new digital emergency medical services report form generated.

When the user finishes entering the settings, the user preferably selects Save 190 to save the information entered into the Settings Screen 150 and exit the Settings Screen 150. Alternatively, the user may select Cancel 195 to clear the information from the Settings Screen 150 and exit the Settings Screen 150.

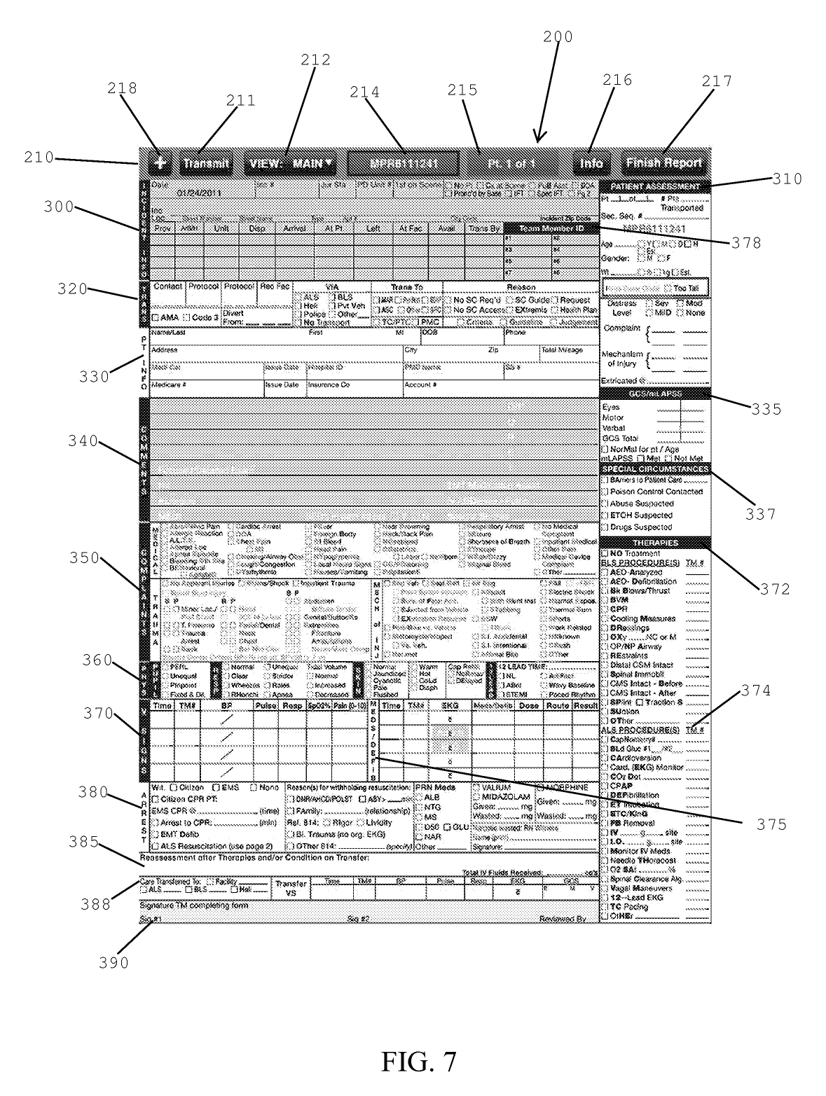

FIG. 7 is a screen shot of a display of an electronic processing unit and shows the main screen of one embodiment of the digital emergency medical services report form. The digital emergency medical services report form main screen 200 acts as a base for most of the user's interaction with the present invention. The digital emergency medical services report form main screen 200 is preferably comprised of the following sections: a navigation menu 210; Incident Information 300; Transportation 320; Patient Assessment 310; Patient Info 330; GCS/mLAPSS 335; Special Circumstances 337; Comments 340; Complaints section 350; Physical Characteristics 360; Vital Signs 370; Therapies 372; ALS Procedures 374; Team Member IDs 378; Cardiac Arrest 380; and Reassessment after Therapies 385; Transfer Section 388; Medications and defibrillations 375; and a signature section 390. Each of the aforementioned sections on the digital emergency medical services report form is designed to mimic a section on the currently used paper version of the EMS Report Form. FIG. 7 also shows that, preferably, each of the sections of the digital emergency medical services report form has a plurality of report data fields. These report data fields also preferably mimic the paper EMS Report form. Because EMS professionals and responders are already trained how to fill out the paper EMS Report form, lengthy and detailed training is not required to use the present invention. For example, the comments section on the paper report is used to document critical information that the user will not enter into the other sections of the report. Similarly, the present invention, which includes a Comments 340 section, also allows the user to enter critical information that the user will not enter into the other sections of the report.

FIG. 7 also shows that the navigation screen preferably has several options including, but not limited to: page/form View 212; Transmit 211; Unique Identification Number 214; Patient No. 215; Info; 216; and Finish Report 217. The Unique Identification Number 214 or unique emergency medical services report number is a sequence of alphanumeric characters that is a combination of a plurality of identification codes. The plurality of identification codes are preferably selected from the group consisting of: a provider code; a numeric date code; a year code; a unit number; and a unit code. The unique emergency medical services report number ensures that each report has a unique number that is not duplicated anywhere in the world, and contains information that allows a medical provider to know with ease when the emergency report was generated and who the responders were. This is because the unique number includes date, provider, and unit identification codes that are linked to the actual responder team that first arrived at the scene of the emergency.

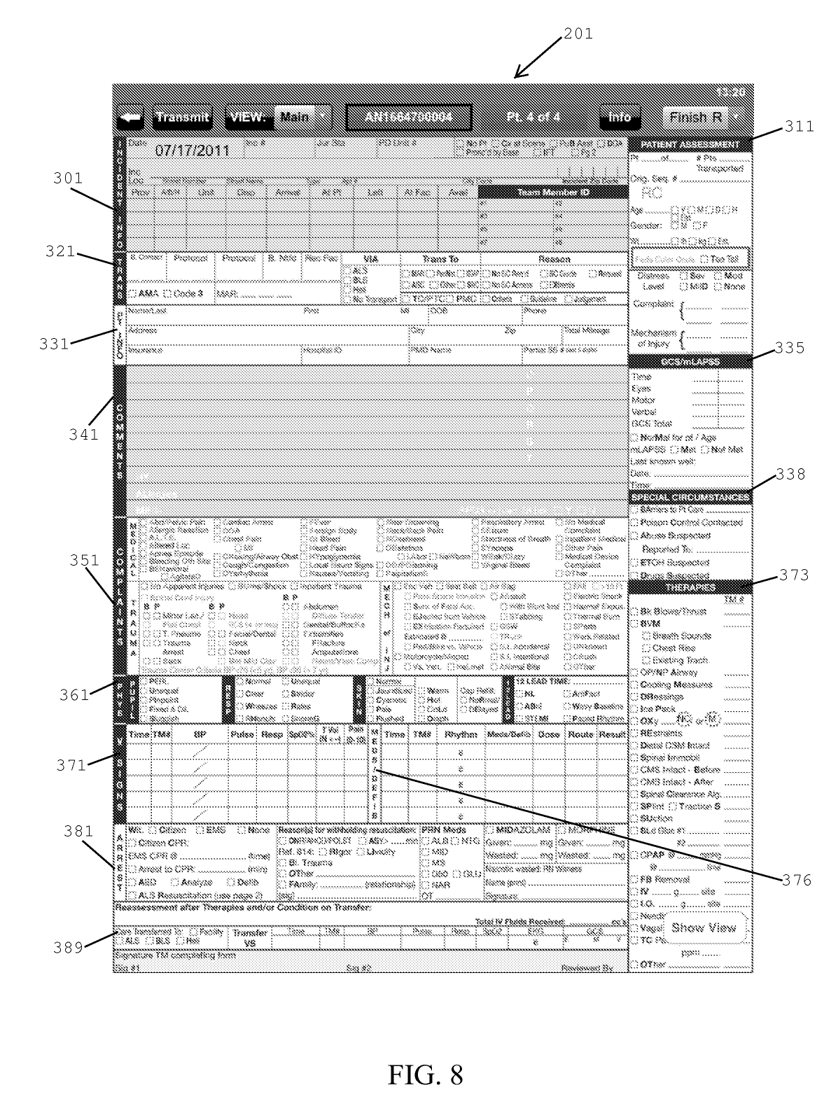

FIG. 8 is a screen shot of a display of an electronic processing unit and shows the main screen of another embodiment of the digital emergency medical services report form. The digital emergency medical services report form main screen 201 acts as a base for most of the user's interaction with the present invention. In this embodiment of the digital form, the digital emergency medical services report form main screen 201 comprises the following sections: Incident Information 301; Patient Assessment 311; Transport 321; Patient Information 331; Comments 341; Complaints 351; Physical 361; Vital Signs 371; Therapies 373; Medications and Defibrillations 376; Arrest 381; and Care Transferred To 389. Each of the aforementioned sections on the digital emergency medical services report form is designed to mimic a section on a currently used paper version of an EMS Report Form. However, important upgrades to the sections and fields can be made during the conversion of the currently used paper versions to the digital medical services report form. Such upgrades would preferably provide a more efficient digital emergency medical services report form for EMS professionals and responders, and avoid needless duplication of information. For example, the Transport 321 Section of the digital emergency medical services report form contains two “Protocol” fields. Although on the currently used paper version there are only three lines to insert characters, in converting the currently used paper version to the digital medical services report form, four lines are preferably provided, which allows for documentation of the complete protocol number. Furthermore, in the Patient Assessment 311 Section, clarifications and ease of readability has been accomplished by changing “Sec. Seq. #” that is present on the currently used paper version to “Orig. Seq. #”. Also, under Patient Information 331 section, some of the fields have been altered from the currently used paper version to better clarify or avoid duplication of data. Preferably, the field “Insurance” has been provided to facilitate documentation of any insurance type, rather than just “Medi-Cal”, as is provided in the currently used paper version. Furthermore, only the last five digits of the patient's Social Security Number is necessary, and this is reflected in the converted field “Partial SS # (last 5 digits)”. Additionally, columns with the headings “T Vol (N+−)” and “SpO₂” have been preferably added to the Vital Signs 371 section. Finally, many of the unnecessary checkbox options in the Therapies 372 section, have been removed in converting the currently used paper version to the digital medical services report form, and, clarifying options have been added, including, but not limited to, “Breath Sounds”, “Chest Ride”, “Existing Trach.”, and “Ice Pack”.

Because EMS professionals and responders are already trained how to fill out the currently used paper version of the EMS Report form, lengthy and detailed training is not required to use the present invention. In any embodiment of the digital emergency medical services report form, the fields of the digital emergency medical services report form can be altered depending on the needs of the particular group of users. For example, the EMS professional and responders in one geographic area will require different fields in the digital emergency medical services report form than the EMS professionals and responders in another geographic area. Furthermore, important upgrades to the fields of the emergency medical services report form can be made during the conversion from the currently used paper version to the digital emergency medical services report form. Preferably, the upgrades that occur during the conversion to the digital medical services report form remain similar enough to the currently used paper version so that those who are familiar with the currently used paper version would still be able to complete the digital emergency medical services report form easily and efficiently. Furthermore, the present invention, which includes a Comments 341 section, also allows the user to enter critical information that the user will not enter into the other sections of the report.

Preferably, the sections of either embodiment of the digital emergency medical services report form are completed by selecting that section and then completing a pop-up window which magnifies the report data fields of that section. This makes it easier for the user to complete the form on the electronic processing unit of the present invention.

FIG. 7 and FIG. 8 are not intended to limit the embodiments of the digital emergency services report form, but rather to provide two examples of the digital emergency services report form. Because of the thousands of varying currently used paper version EMS report forms, it is within the scope of this invention for thousands of varying digital emergency medical services report forms to exist, reflecting whatever specific paper version EMS report forms are currently used in any given geographic area.

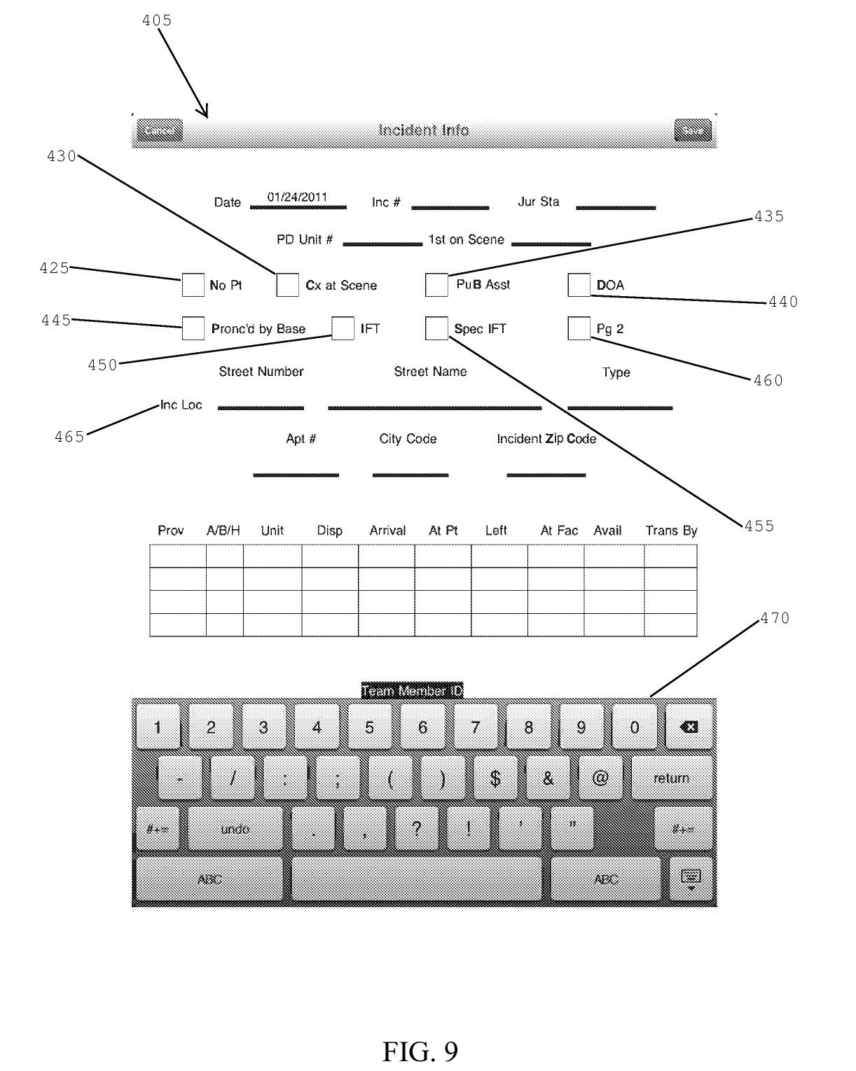

FIG. 9 is a screen shot of a display of an electronic processing unit and shows the “Incident Info” section screen of one embodiment of the digital emergency medical services report form. The Incident Info screen 405 pops up when a user selects the Incident Info 300 section from the main screen of the digital emergency medical services report form. FIG. 9 shows that the data report fields in the Incident Info section are duplicated and enlarged in the Incident Info screen 405. This allows the user to quickly and easily populate the data report fields of the selected section.

As shown in FIG. 9, most of the data report fields of the Incident Info screen 405 are populated with a pop up touch screen keypad 470. It would be understood that a separate keyboard may also be used to input data into the data report fields without deviating from the scope of the invention. FIG. 9 also shows that some of the data fields may be checkboxes, such as “No Pt” checkbox 425, which is checked when “No Patient” is treated during the emergency response incident. Another example of the check boxes is the “Cx at Scene” checkbox 430, which means “Canceled at Scene” and is selected when, upon arrival at scene, the responding unit is canceled by, for example, another first responder who is on scene and has determined that the later arriving unit is not needed. When canceled at scene is marked, the unit preferably has not had patient contact.

FIG. 9 also shows the “PuB Assist” checkbox 435 means “Public Assist.” The trained EMS professional selects this option when they respond to a request for lifting assistance (bed to chair, chair to bed, car to home, etc.) and the individual is determined not to have an illness or injury. Responses where an individual or third party called 9-1-1 for a possible medical issue should be considered a full call and appropriate patient assessment and documentation should be completed. For example, if a third party calls for a “person down” and upon arrival the person is fully oriented and denies illness or injury. The “DOA” checkbox 440 should be used when the patient is dead on arrival and is pronounced per the jurisdiction's Pre-hospital Care Policy Manual. The user of the present invention is used to the emergency medical services report form and will know to fill out the “Comments” 340 section to include documentation of physical findings. The “Pronc'd by Base” checkbox 445 may be selected if the patient does not meet criteria specified in the jurisdiction's Pre-hospital Care Policy Manual and cannot be determined to be dead.

The “IFT” checkbox 450 is used when there is an Inter-Facility Transport, or when the patient is transferred on an elective, non-emergency basis from one medical facility to another. This type of response is usually accepted only by a private ambulance company and is scheduled. This box is not checked for 9-1-1 emergency responses to convalescent hospitals or medical offices. Occasionally a 9-1-1 unit is called to transport a patient from an Emergency Department to a higher level of care facility, such as a Trauma Center. In terms of documentation, IFTs can be categorized as either outpatient (typically a call originating from an emergency department), or inpatient (a call originating from a hospital ward or ICU). All inpatients will be classified as either medical or trauma.

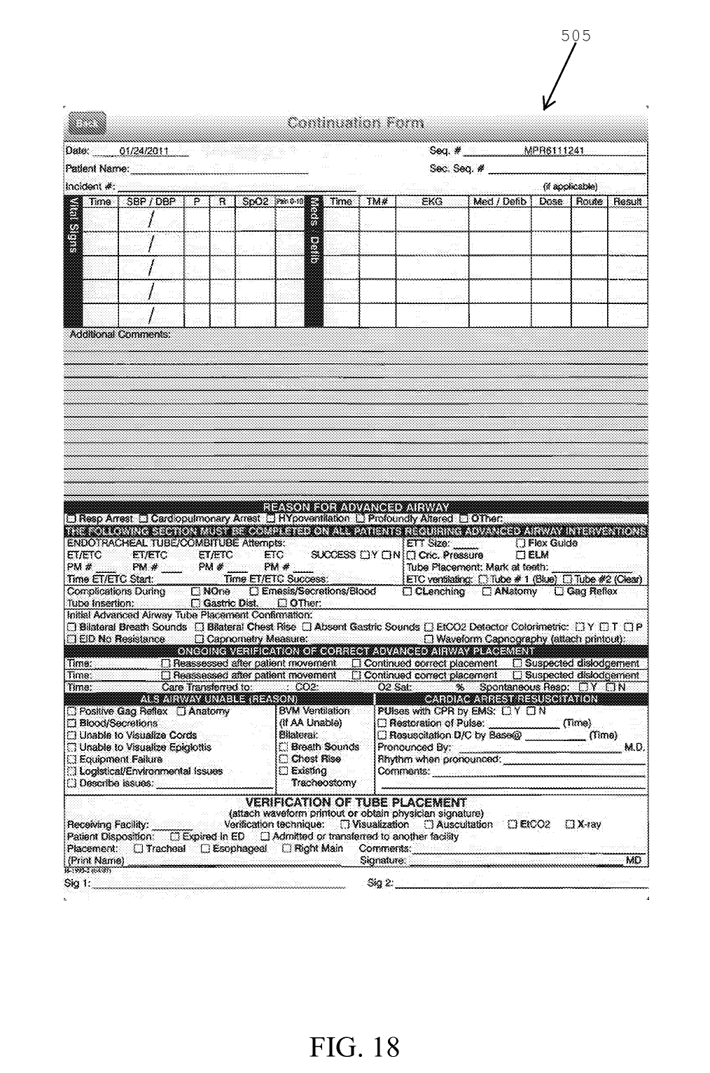

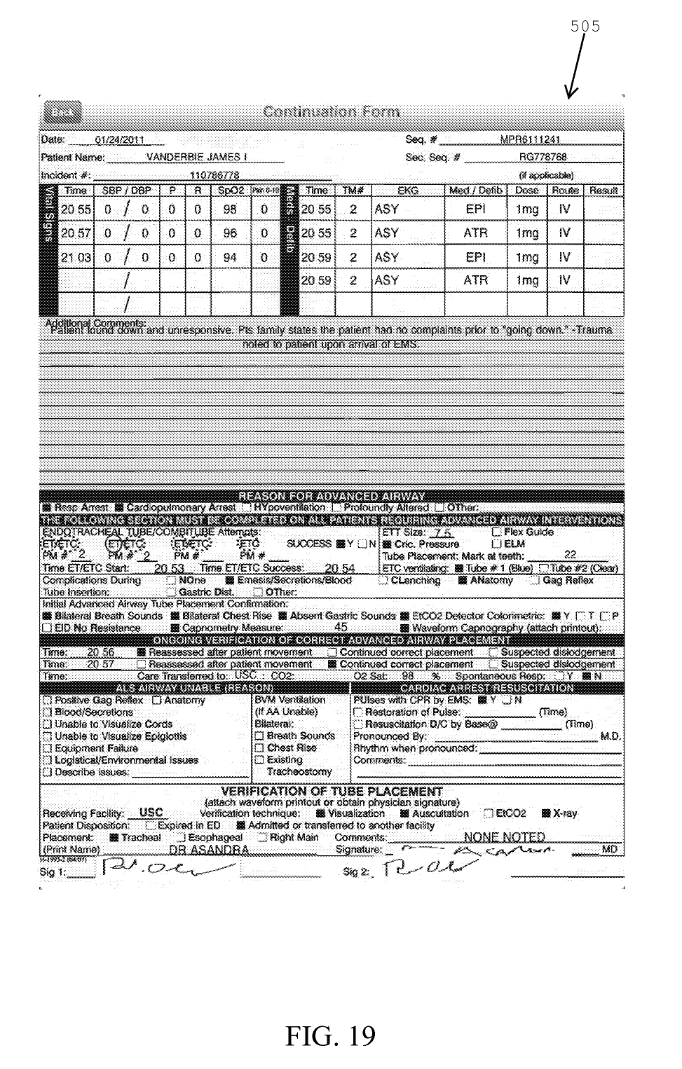

The “Spec IFT” means “Special Inter-facility Transport.” The “Spec IFT” checkbox 455 should be selected when an ALS level IFT done by a provider agency that has been approved by the EMS Agency to utilize one (1) paramedic and one (1) EMT-I staffing for IFTs. The “Page 2” checkbox 460 is selected when another screen to the digital emergency medical services report form 200 is required to document all the information about the incident and response (as shown in FIGS. 18 and 19).

The “Inc Loc” field 465 details where the incident took place. When the user clicks on any of the fields in the Inc Loc field 465 area, the user may type in address information for the incident into the keypad 470. The keypad 470 may be available virtually, internal to the incident report form software, or externally to the electronic device software. The “Inc Loc” field 465 may include, but are not limited to, street number, street name, type of home, apartment or suite number, city code, and zip code.

As with each section on the digital emergency medical services report form, the user was previously trained on the meaning of each portion of the paper emergency medical services report form and can easily translate this knowledge to the digital emergency medical services report form in completing the data report fields in screen 200.

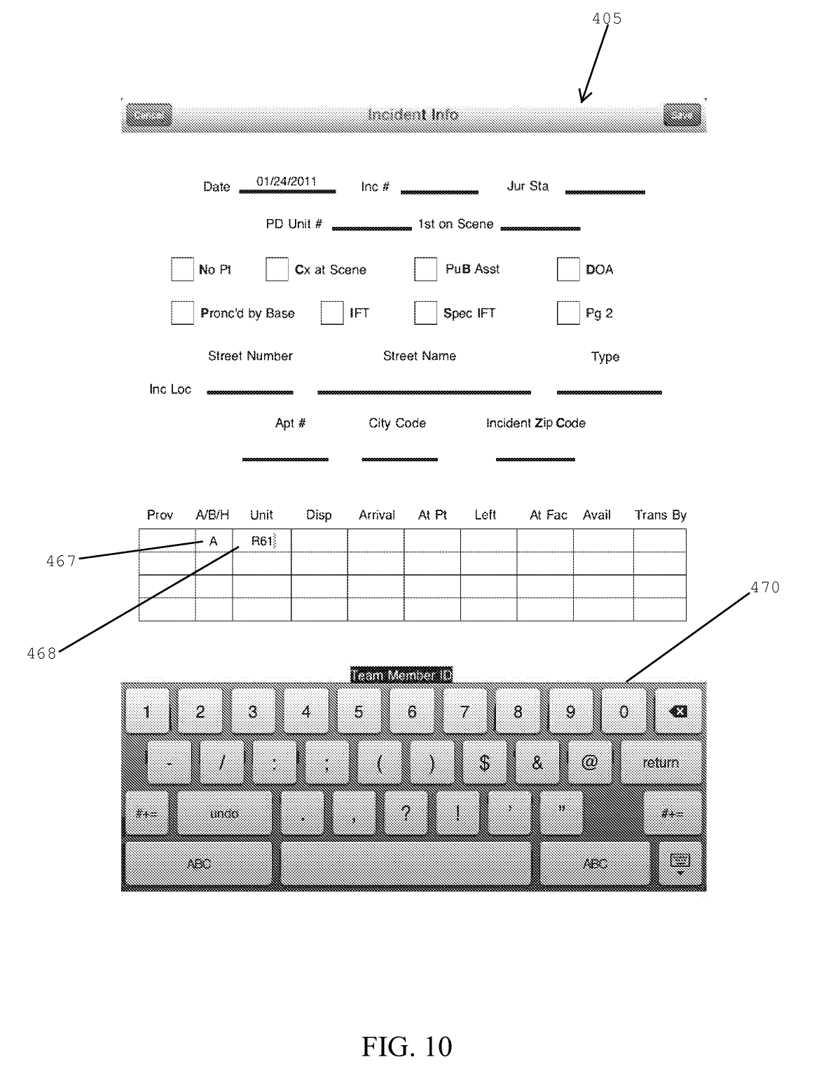

FIG. 10 is a screen shot of a display of an electronic processing unit and shows the user filing in the Incident Info section screen of one embodiment of the digital emergency medical services report form. As shown in FIG. 10, the keypad 470 is preferably used to enter data into the Incident Info screen 405. The letter “A” is shown having been entered into A/B/H data report field 467, and “R61” has been entered into Unit data report field 468. Preferably, the user continues to fill in fields until all of the appropriate fields are filled in.

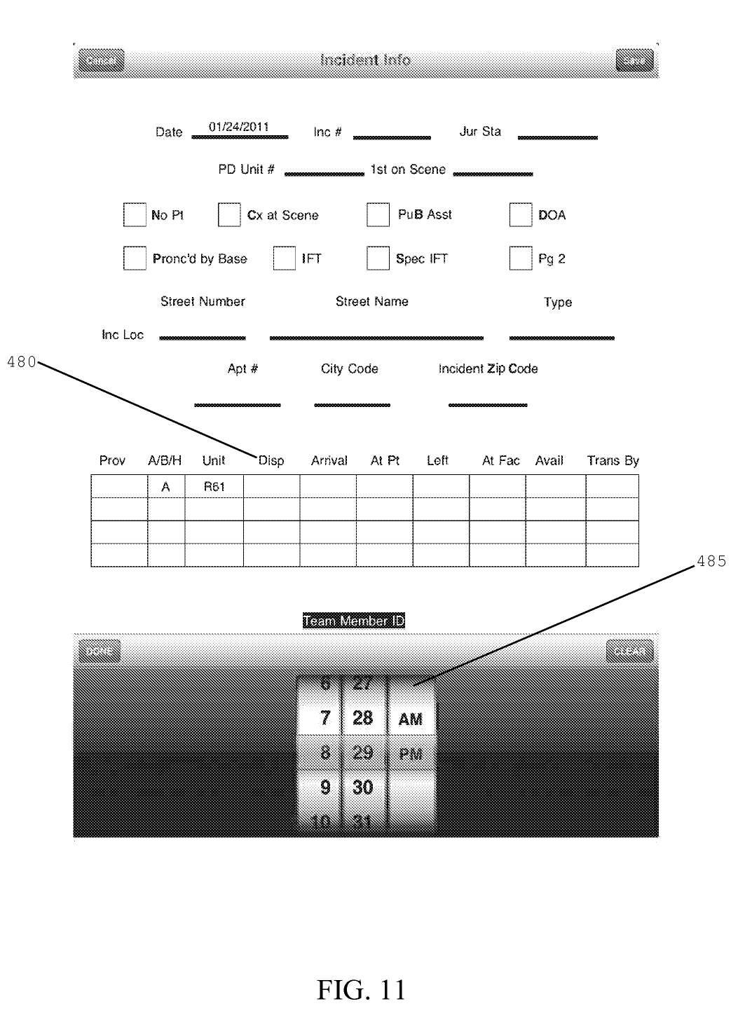

FIG. 11 is a screen shot of a display of an electronic processing unit and shows the user filing in the dispatch time in the Incident Info section screen of one embodiment of the digital emergency medical services report form. FIG. 11 shows that certain fields require the user to input time data. “Disp” 480, which stands for Dispatch Time, is one of several data report fields that require a time entry. Others include, but are not limited to, dispatch time, arrival time, arrival time of EMS professional at the patient's side, left the scene to transport the receiving facility, arrival time at the receiving facility, and time the EMS professional was available to respond to another call. When a field is selected that requires time data, a time wheel 485 pops up and allows the user to scroll to the desired time data. In alternate embodiments, the user may type the time into the desired fields as well.

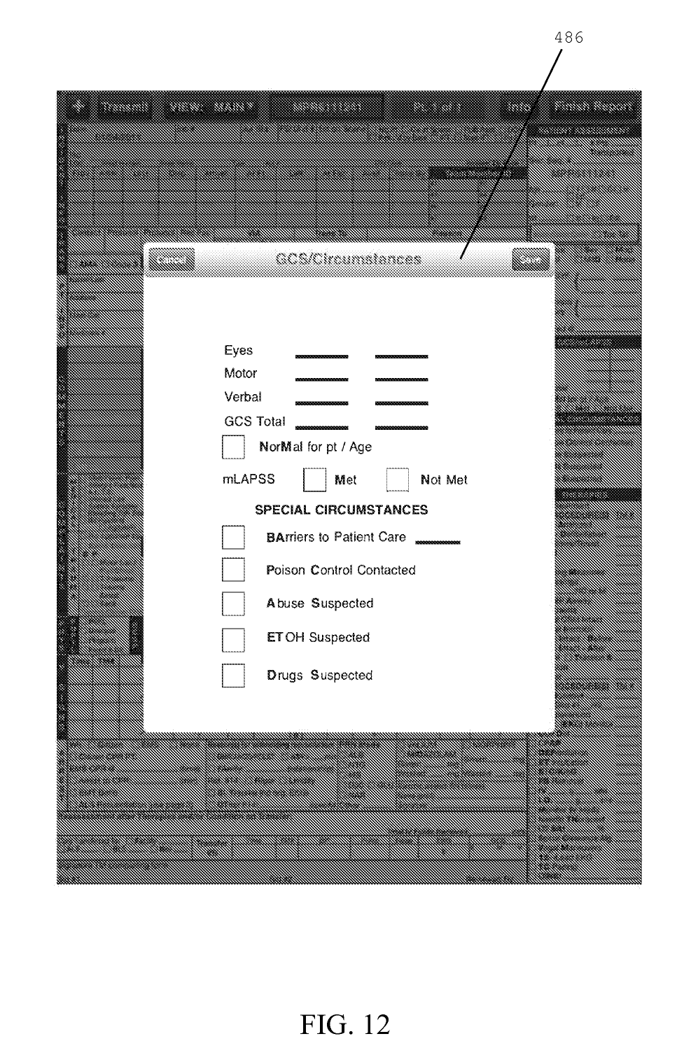

FIG. 12 is a screen shot of a display of an electronic processing unit and shows the “GCS/Circumstances” section screen of one embodiment of the digital emergency medical services report form. FIG. 12 shows another section of the digital emergency medical services report form that has been selected by the user. In this case, the user selected the GCS/Circumstances sections 335, 337, which causes the GCS/Circumstances screen 486 to be displayed. The user is then able to enter data into the data report fields. GCS stands for Glasgow Coma Score. The GCS/Circumstances sections 335, 337 preferably utilize a numerical system describing a patient's level of consciousness and the patient's response to external stimuli. Space is provided for each individual component (eye, motor, and verbal) of the scale as well as the total GCS. The initial GCS is documented on the left. The reassessment of the GCS due to possible changes in the patient's condition is documented on the right. Comments regarding physical resistance to exam and treatment should be made in the Comments Section 340. Below the initial GCS indicators are additional check boxes, which include “NorMal PT/Age” (Normal for Patient or Age); “mLAPSS” (Modified Los Angeles Stroke Screen); Barriers to Patient Care (such as blind, deaf, combative, speech impaired, altered, etc.); Poison control contacted; Abuse suspected; ET OH Suspected; and Drugs Suspected.

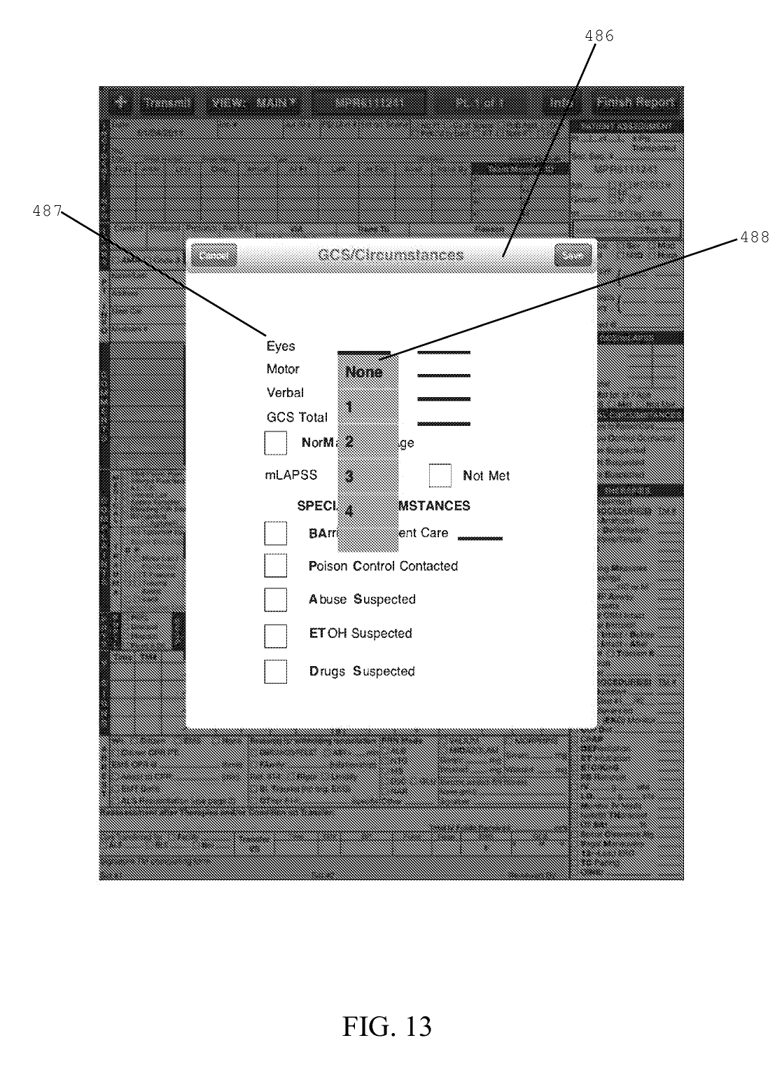

FIG. 13 is a screen shot of a display of an electronic processing unit and shows the user filing in the “GCS/Circumstances” section screen of one embodiment of the digital emergency medical services report form. FIG. 13 shows that the user has selected the “Eyes” 487 data report field within the GCS/Circumstances screen 486. The user is presented with a list of options in a drop down menu 488. The user then selects one of the options and that option is populated into the Eyes 487 data report field. When the user selects the any of the text areas for Eyes, Motor, Verbal, or GCS Total, preferably a dropdown box will appear with a plurality of GCS values, as seen in FIG. 13. The user will select one of the GCS values and that GCS value will remain in the text area for Eyes, Motor, Verbal, or GCS Total. In addition to selecting GCS values from a dropdown box, the user may also select a checkbox next to the GCS indicators, as applicable. The checkboxes may include “NorMal PT/Age” (Normal for Patient or Age); “mLAPSS” (Modified Los Angeles Stroke Screen); Barriers to Patient Care (such as blind, deaf, combative, speech impaired, altered, etc.); Poison control contacted; Abuse suspected; ET OH Suspected; and Drugs Suspected.

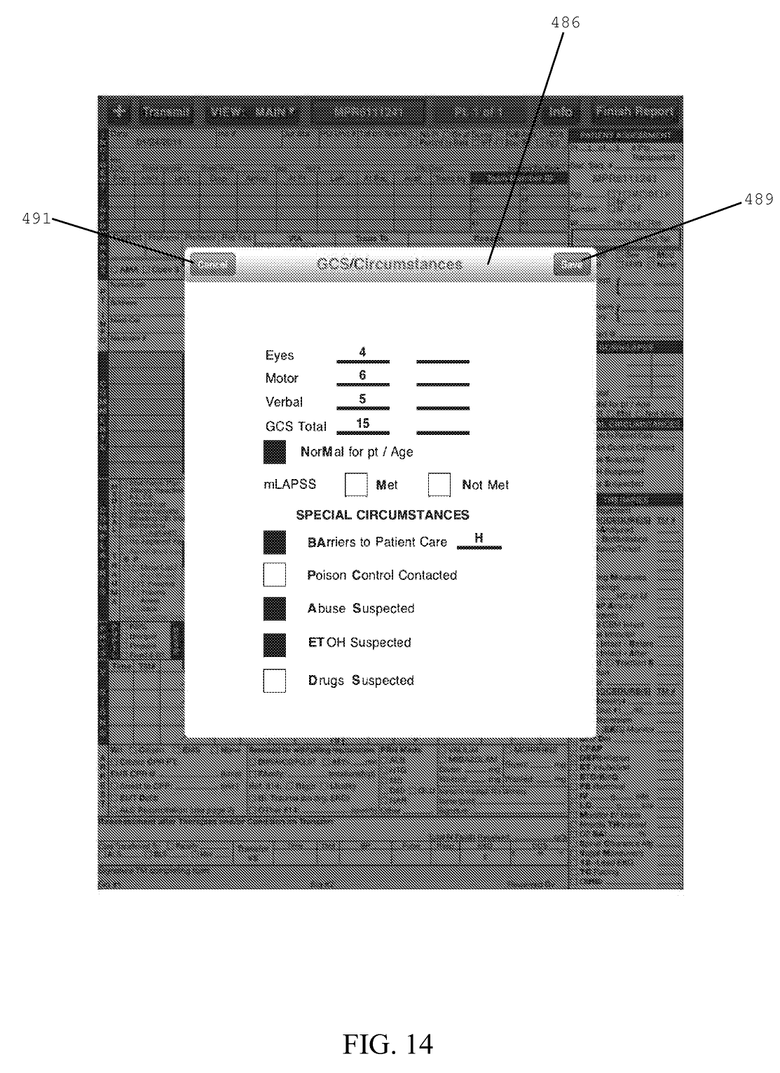

FIG. 14 is a screen shot of a display of an electronic processing unit and shows the user continuing to fill in the “GCS/Circumstances” section screen of one embodiment of the digital emergency medical services report form. FIG. 14 shows that the user as completed many of the data report fields of the GCS/Circumstances screen 486. To save exit the GCS/Circumstances screen 486, the user clicks on Save 489. To clear the fields and exit, the user would preferably click on Cancel 491.

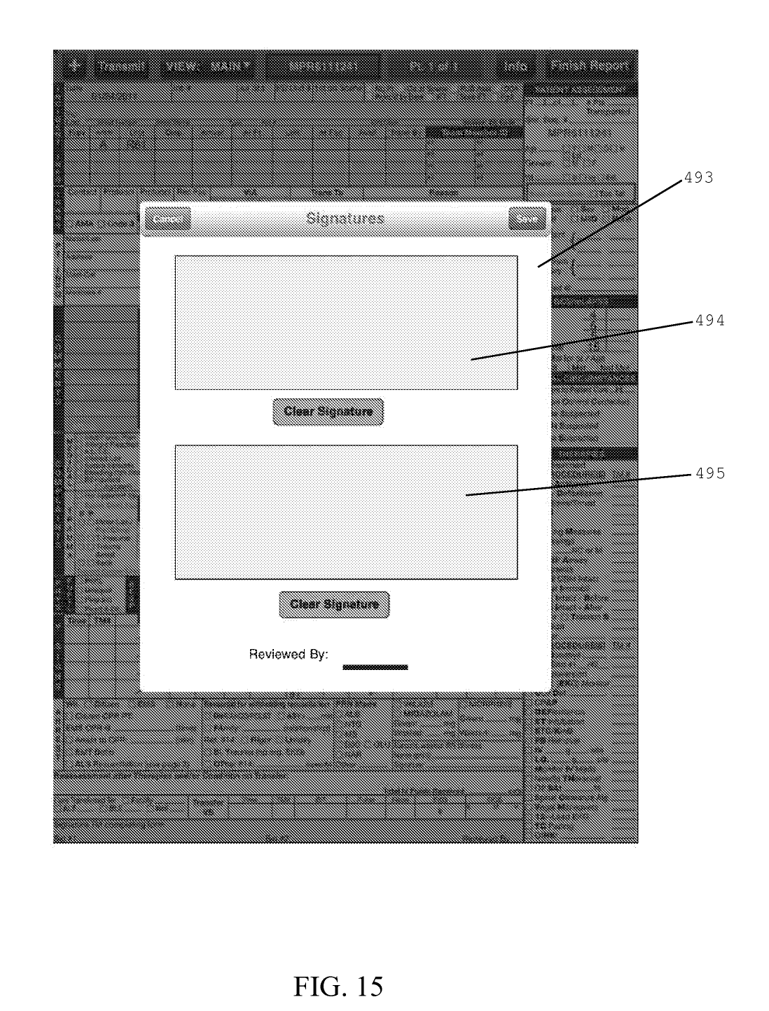

FIG. 15 is a screen shot of a display of an electronic processing unit and shows the “signature” section screen of one embodiment of the digital emergency medical services report form. When the user has completed entering data into the digital emergency medical services report form of the present invention, the user may select the signature 390 section. The electronic processing unit then causes signature screen 493 to be displayed. The users are then able to use a stylus or their fingers to sign the signature boxes 494 and 495.

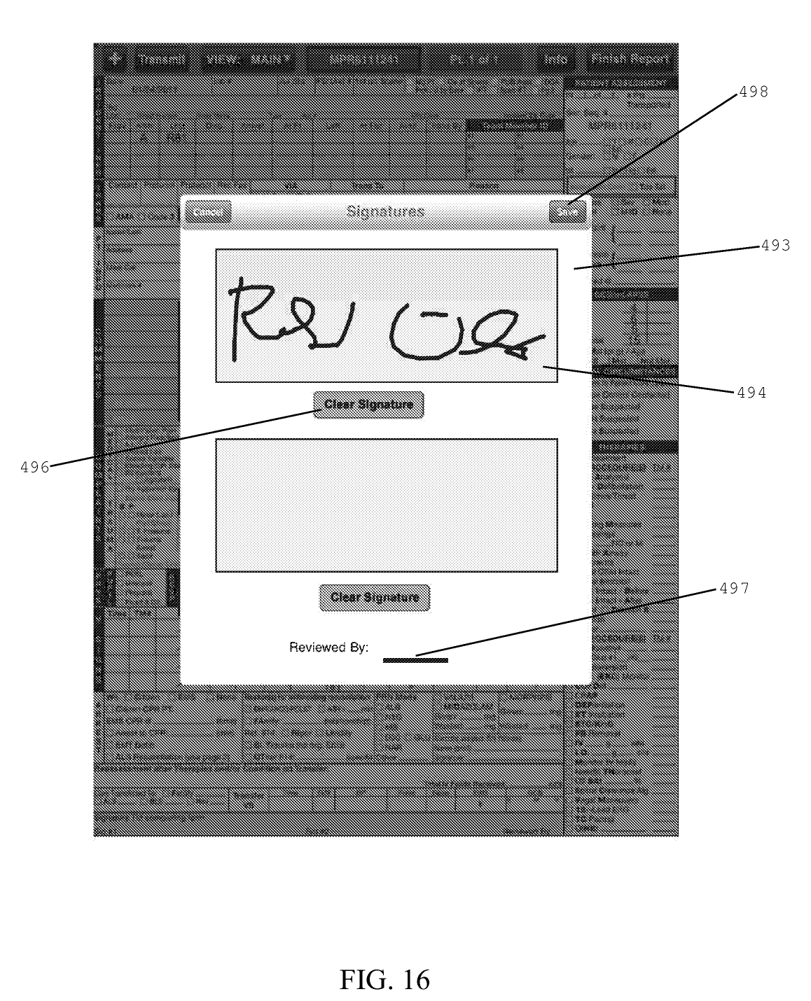

FIG. 16 is a screen shot of a display of an electronic processing unit and shows the user digitally signing the “signature” section screen of one embodiment of the digital emergency medical services report form. FIG. 16 shows that a user has captured an electronic signature in signature box 494. If the user wants to re-sign, the user preferably clears the signature using the Clear Signature 496 option. Preferably, there is also a Reviewed By 497 box, which digitally captures a reviews initials. Alternatively, the reviewer may sign a printed version of the digitally completed form. To save and exit the signature screen 493, the user clicks on Save 498.

Preferably, the user, patient, or other individual whose signature is required in the digital emergency medical services report form, presses, enters, or captures their signature into the touch-sensitive screen of the electronic device. The user can sign their name using a stylus, finger, or other similarly-pointed device and pressing one end of the pointed device against the screen. The electronic processing unit then translates the pressure from the pointed device to digital input. The digital input in this case is a signature. The image of the electronic signature is saved to the data file and can be transported with the rest of the digital emergency medical services report form and inputted data.

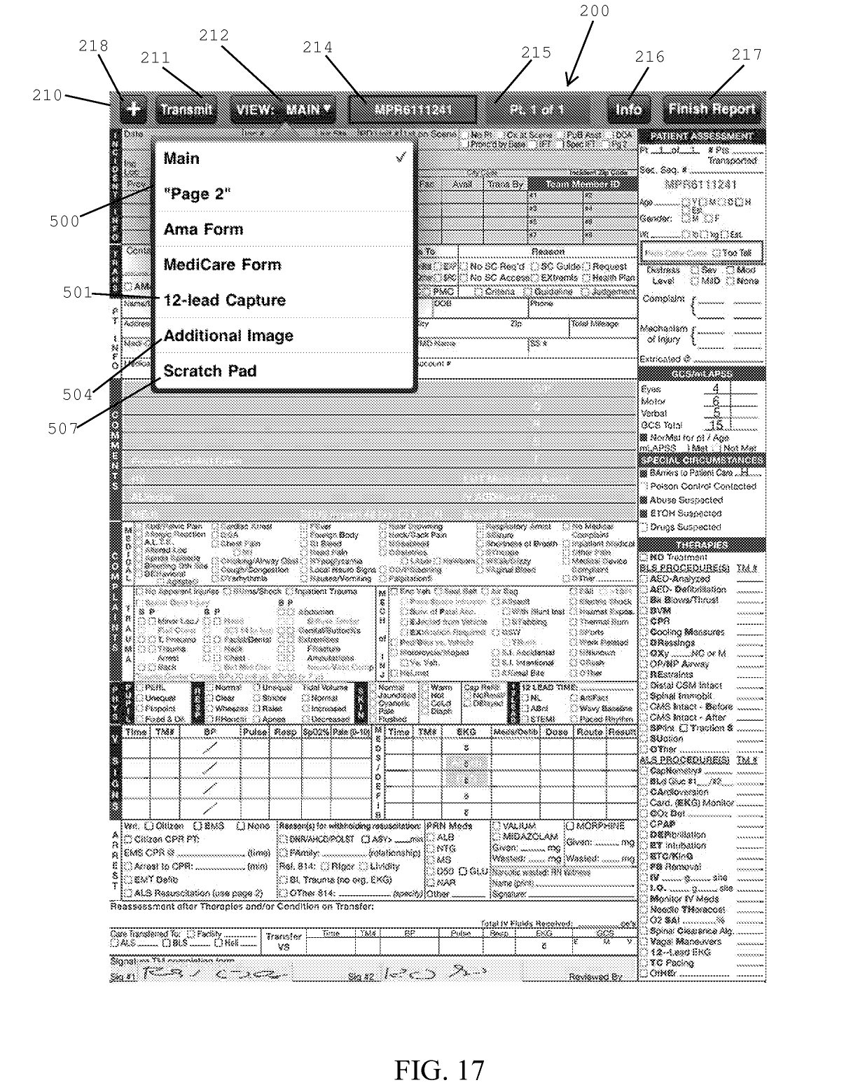

FIG. 17 is a screen shot of a display of an electronic processing unit and shows the screen selection drop down menu on the navigation bar of one embodiment of the digital emergency medical services report form. FIG. 17 shows that the navigation screen preferably has several options including, but not limited to: page/form View 212; Transmit 211; Unique Identification Number 214; Patient No. 215; Info; 216; and Finish Report 217. When the page/form View 212 option is selected, a drop down menu 500 is displayed, which allows a user to pull up a different form or page that is associated with the digital emergency medical services report form. Preferably these pages include “Page 2” or the Continuation Form page, “AMA Form,” “MediCare Form,” “12-lead Capture” 501, “Additional Image” 504, and/or “Scratch Pad” 507.

The 12-lead Capture 501 option is used when the EMS provider or responder wishes to take a digital photograph of the printed hardcopy 12-lead strip that is generated by an EKG device. The 12-lead digital photograph is used for documentation purposes only and is not normally used for diagnoses of heart arrhythmia. Selecting the 12-lead Capture 501 option preferably takes the user to a screen that allows the user to take a digital photograph of the 12-lead strip and save it with the digital emergency medical services report form. The screen would display an image of the object toward which a camera, which is integrated with the electronic processing unit, is directed. Preferably object is a 12-lead strip printout that had been generated by an EKG device. In the alternative, selecting the 12-lead Capture 501 option takes the user to a screen that provides an option to browse previously taken digital photographs of a 12-lead strip. Choosing this option to browse previously taken digital photographs of a 12-lead strip, preferably then allows the user to select the correct saved digital image and save it with the digital emergency services report form. Preferably, the browse option would be used if the digital photograph of the 12-lead strip had been taken at the time the EKG was performed, but the EMS provider or responder does not complete the digital emergency medical services report form until a subsequent time.

The Additional Photo 504 option is used when the EMS provider or responder wishes to take and send an additional digital photograph along with the digital emergency services report form for documentation purposes. For example, the EMS provider or responder may choose to take a digital photograph of a traffic accident scene to demonstrate the intensity of the crash, or of specific contusions or other injuries on the patient. With the Additional Image 504 option, the user could select to have such digital photographs saved with the digital emergency services report form and sent to the appropriate facility to which the patient is transported. Selecting the Additional Image 504 option preferably takes the user to a screen that allows the user to take a digital photograph of an object with the camera that is integrated within the electronic processing unit. In the alternative, selecting the Additional Image 504 option takes the user to a screen that provides an option to browse previously taken digital photographs. Choosing this option to browse previously taken digitally photographs, preferably then allows the user to select the correct saved image and save it with the digital emergency services report form. Preferably, the browse option would be used if the digital photograph had been taken at the time the EMS provider or responder is on the scene, but the EMS provider or responder does not complete the digital emergency medical services report form until a subsequent time.

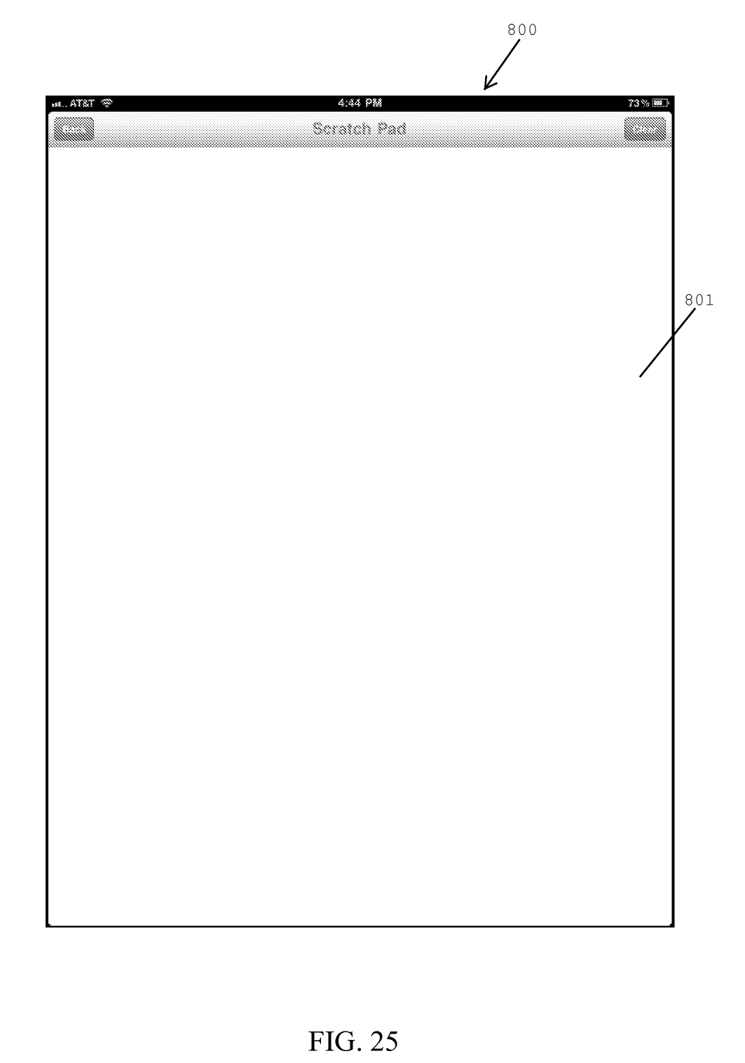

The Scratch Pad 507 option allows the user to make notes that can later be referenced when completing the report. Selecting the Scratch Pad 507 option preferably takes the user to a screen that shows the “Scratch Pad” screen 700 (as shown in FIG. 25). Preferably using an electronic stylus, the EMS provider or responder is able to take and save electronic notes in critical emergency situations where everything is happening very fast, such as a gunshot incident with multiple victims.

FIG. 18 is a screen shot of a display of an electronic processing unit and shows the “Continuation Form” screen of one embodiment of the digital emergency medical services report form. FIG. 18 shows the Continuation Form 505 screen, which allows the user to input additional data about the specific incident. Preferably, the Continuation Form 505 screen is essentially identical to a paper form already in use in the users jurisdiction.

FIG. 19 is a screen shot of a display of an electronic processing unit and shows a completed “Continuation Form” screen of one embodiment of the digital emergency medical services report form. FIG. 19 shows the Continuation Form screen 505 having been completed and signed by the user, preferably through the use of pop-up data entry screens. Just as with the main screen 200, the data is entered into Continuation Form screen 505 one section at a time. However, it should be understood that the form screens 200 and 505 may be completed directly without the use of pop-up data entry screens, without deviating from the scope of the invention.

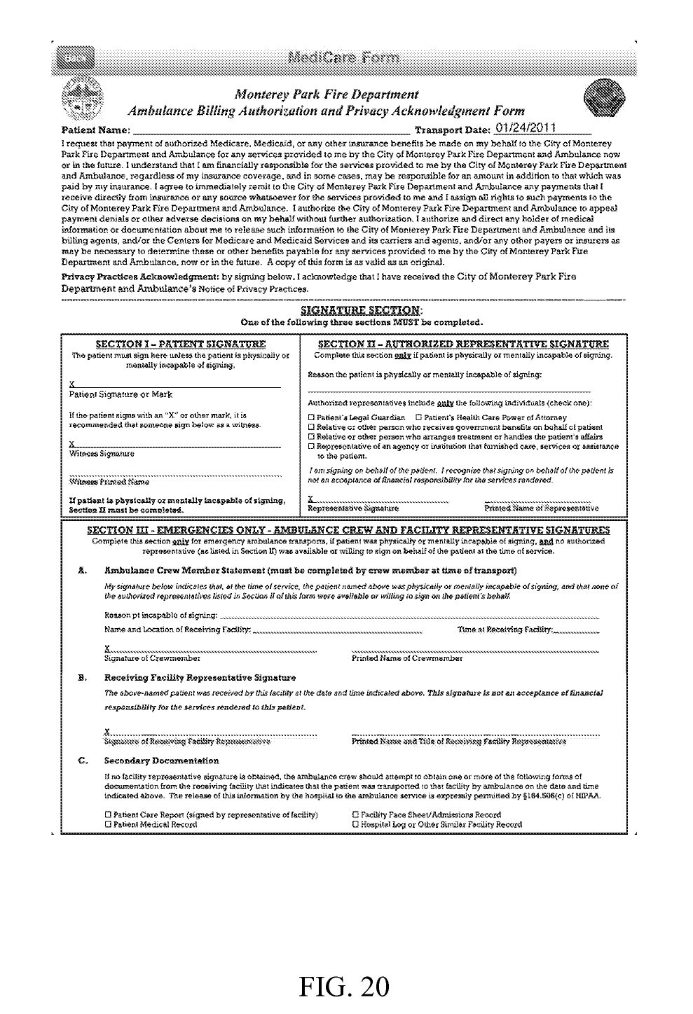

FIG. 20 is a screen shot of a display of an electronic processing unit and shows the “MediCare Form” screen of one embodiment of the digital emergency medical services report form. Preferably, the MediCare Form screen is essentially identical to the paper MediCare Form used in the user's jurisdiction.

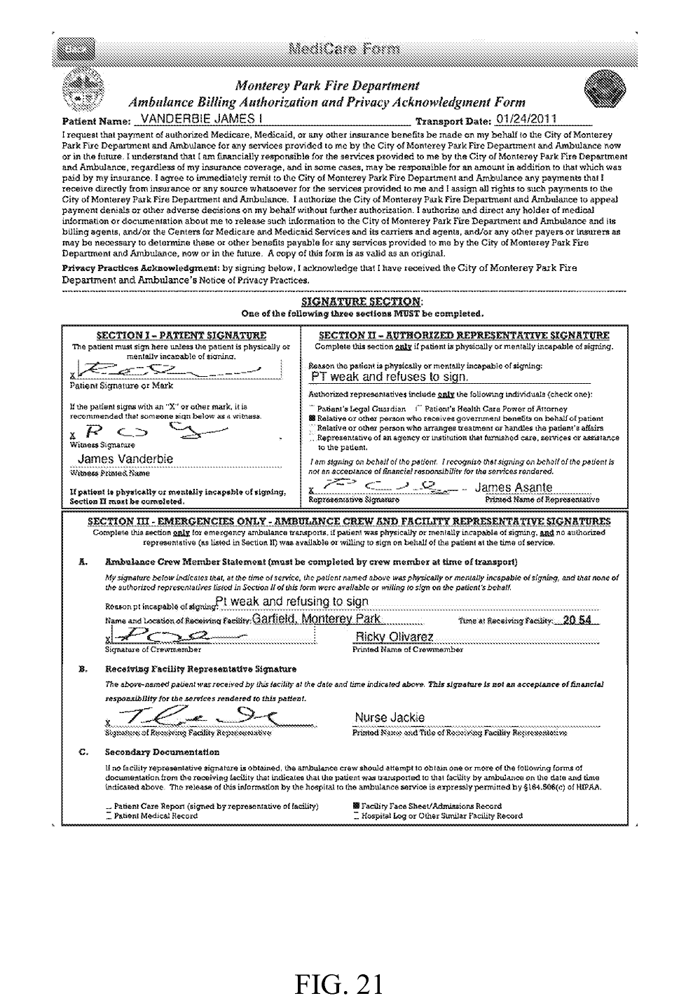

FIG. 21 is a screen shot of a display of an electronic processing unit and shows a completed “MediCare Form” screen of one embodiment of the digital emergency medical services report form.

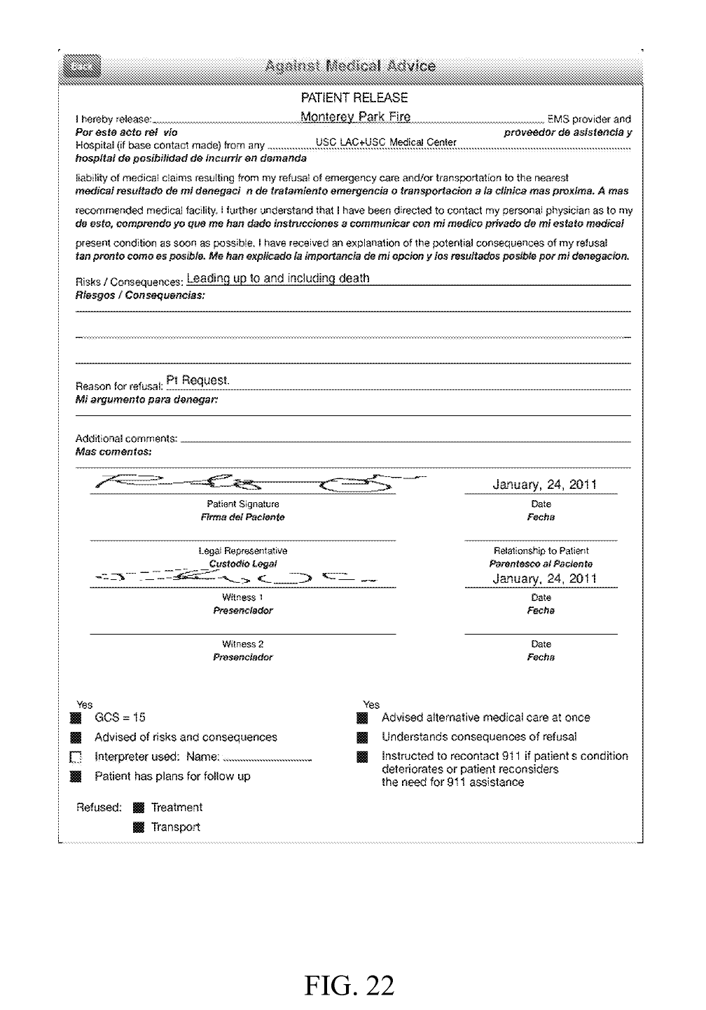

FIG. 22 is a screen shot of a display of an electronic processing unit and shows a completed “Against Medical Advice” screen of one embodiment of the digital emergency medical services report form. Preferably, the Against Medical Advice Form screen is essentially identical to the paper Against Medical Advice Form used in the user's jurisdiction.

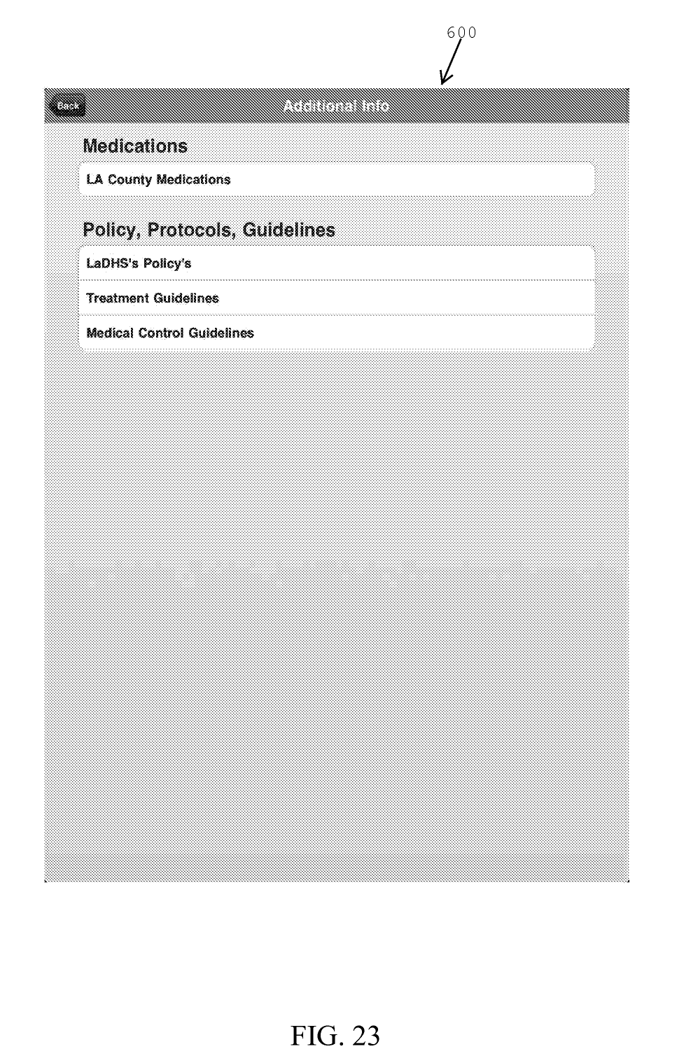

FIG. 23 is a screen shot of a display of an electronic processing unit and shows the “Additional Info” menu screen of one embodiment of the digital emergency medical services report form. The Additional Info menu screen 600 preferably provides links to additional information regarding medications, jurisdictional policies, treatment guidelines, and/or medical protocols. Any information useful to the emergency medical response personnel may be provided.

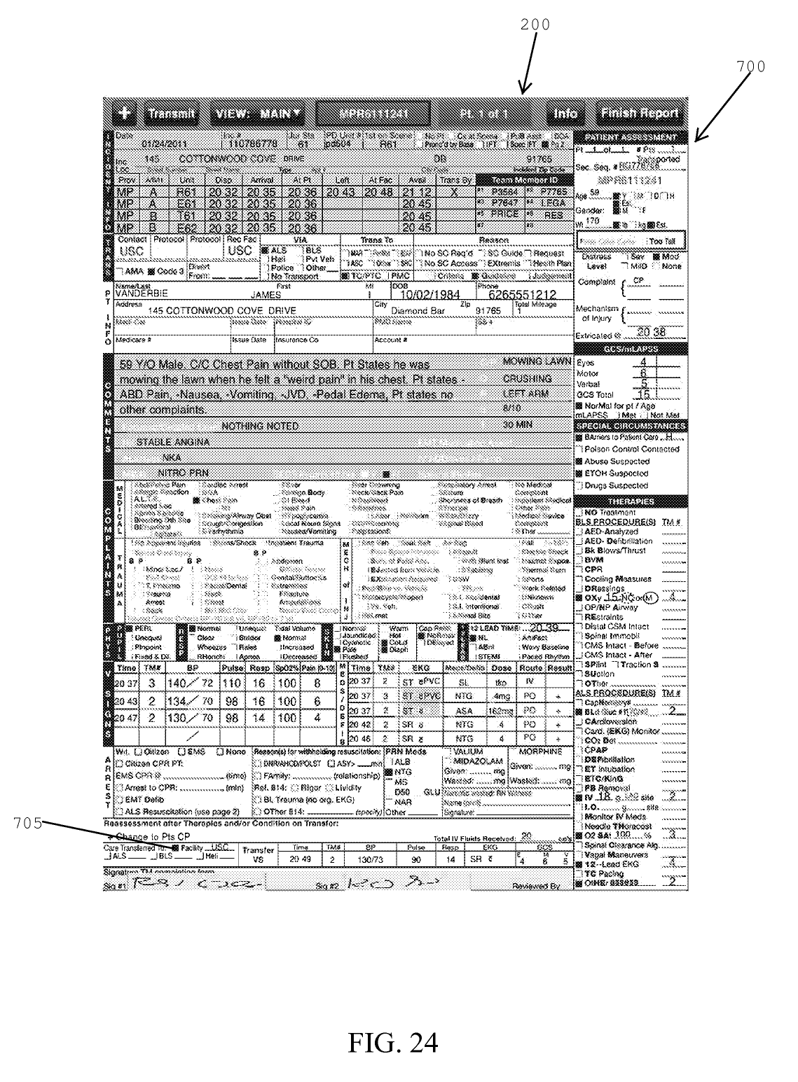

FIG. 24 is a screen shot of a display of an electronic processing unit and shows one embodiment of a completed and signed digital emergency medical services report form. FIG. 24 shows that a user has digitally entered incident data into the digital emergency medical services report form main screen 200. The data report fields that could be completed are and now the completed form 700 may be saved or transmitted to the medical facilities that later treat the patient. Completed form 700 shows that this patient will be transferred to Facility 705 “USC”.

After the form is closed, saved, and/or transmitted, preferably, the user can later review the entered data and/or saved form, by accessing the form through the home screen 115 (as shown in FIG. 2).

FIG. 25 is a screen shot display of an electronic processing unit and shows the “Scratch Pad” screen 800 of one embodiment of the digital emergency medical services report form. The EMS provider or responder can take notes on the digital scratch pad 801 much in the same way that a user would take notes on a paper notepad. Preferably using an electronic stylus, the EMS provider or responder is able to take and save electronic notes in critical emergency situations where everything is happening very fast, such as a gunshot incident with multiple victims. The electronic notes can then later be referenced when completing the report. Typically, the electronic notes would not be a part of the actual report itself.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for filling out an emergency medical services report form comprising the steps:
providing an electronic data processing unit;
wherein said electronic data processing unit is comprised of a display;
displaying on said display of said electronic data processing unit a digital emergency medical services report form;
wherein said digital emergency medical services report form is comprised of a plurality of sections, including at least a first section and a second section;
wherein each of said sections is comprised of a plurality of report data fields;
responding to a medical emergency incident of a patient by an emergency response unit;
inputting a plurality of incident data into said plurality of report data fields by said emergency response unit;
wherein said digital emergency medical services report form is substantially the same as an existing paper emergency services report form used by said emergency response unit.

2. The computer-based method for filling out an emergency medical services report form of claim 1, further comprising the steps:
using said electronic data processing unit to select between displaying a new digital emergency medical services report form, a previously completed digital emergency medical services report form, and an unfinished digital emergency medical services report form.

3. The computer-based method for filling out an emergency medical services report form of claim 2, further comprising the steps:
generating by said electronic data processing unit a unique emergency medical services report number;
assigning by said electronic data processing unit said unique emergency medical services report number to said new digital emergency medical services report form for said patient;
wherein said unique emergency medical services report number is unique to said new digital emergency medical services report form.

4. The computer-based method for filling out an emergency medical services report form of claim 3, wherein said unique emergency medical services report number is a sequence of alphanumeric characters that is a combination of a plurality of identification codes.

5. The computer-based method for filling out an emergency medical services report form of claim 4, wherein said plurality of identification codes are selected from the group consisting of: a provider code; a numeric date code; a year code; a unit number; and a unit code.

6. The computer-based method for filling out an emergency medical services report form of claim 5, further comprising the steps:
selecting said first section to input said plurality of incident data;
generating and displaying by said electronic data processing unit a first section form, wherein said first section form displays a plurality of first section report data fields, and wherein said plurality of first section report data fields correspond with said plurality of report data fields of said first section;
inputting said plurality of incident data into said plurality of first section report data fields by said emergency response unit;
populating, by said electronic data processing unit, said incident data inputted into said first section form into said plurality report data fields of said selected first section.

7. The computer-based method for filling out an emergency medical services report form of claim 6, further comprising the steps:
selecting said second section to input said plurality of incident data;
generating and displaying by said electronic data processing unit a second section form, wherein said second section form displays a plurality of second section report data fields, and wherein said plurality of second section report data fields correspond with said plurality of report data fields of said second section;
inputting said plurality of incident data into said plurality of second section report data fields by said emergency response unit;
populating, by said electronic data processing unit, said incident data inputted into said second section form into said plurality report data fields of said selected second section.

8. The computer-based method for filling out an emergency medical services report form of claim 7, further comprising the steps:
wherein said plurality of sections is further comprised of a signature section;
selecting said signature section to input one or more signatures of one or more members of said emergency response unit that completed said new digital emergency medical services report form;
digitally inputting said one or more signatures of said one or more members of said emergency response unit that completed said new digital emergency medical services report form.

9. The computer-based method for filling out an emergency medical services report form of claim 8, wherein said new digital emergency medical services report form is further comprised of a navigation menu.

10. The computer-based method for filling out an emergency medical services report form of claim 9, wherein said navigation menu is displayed at a top portion of said new digital emergency medical services report form.

11. The computer-based method for filling out an emergency medical services report form of claim 10, further comprising the steps:
providing one or more supplemental digital emergency medical services report forms;
wherein said one or more supplemental digital emergency medical services report forms are accessed through said navigation menu.

12. The computer-based method for filling out an emergency medical services report form of claim 11, wherein said one or more supplemental digital emergency medical services report forms are selected from the group consisting of: a digital supplemental continuation form; a digital medicare form; and a digital against medical advice form.

13. The computer-based method for filling out an emergency medical services report form of claim 12, further comprising the steps:
wherein said one or more supplemental digital emergency medical services report forms each have a plurality of supplemental data fields; and
inputting a plurality of supplemental incident data into said plurality of supplemental data fields by said emergency response unit.

14. The computer-based method for filling out an emergency medical services report form of claim 13, further comprising the steps:
wherein said navigation menu is further comprised of options selected from the group consisting of: information; supplemental forms; a transmit; and finish report button.

15. The computer-based method for filling out an emergency medical services report form of claim 14, further comprising the steps:
selecting by said emergency response unit said information option;
displaying by said electronic data processing unit an information screen;
wherein said information screen provides a plurality of links to information selected from the group consisting of: medication; treatment guidelines; medical control guidelines; and municipal policies.

16. The computer-based method for filling out an emergency medical services report form of claim 15, further comprising the steps:
completing said new digital emergency medical services report form; and
transmitting said completed emergency medical services report form to one or more medical facilities that receive said patient after said patient is released by said emergency response unit.

17. A computer-based method for filling out an emergency medical services report form comprising the steps:
providing an electronic data processing unit;
wherein said electronic data processing unit is comprised of a display;
using said electronic data processing unit to select between displaying a new digital emergency medical services report form, a previously completed digital emergency medical services report form, and an unfinished digital emergency medical services report form;
selecting said new digital emergency medical services report form;
displaying on said display of said electronic data processing unit said new digital emergency medical services report form;
wherein said new digital emergency medical services report form is comprised of a plurality of sections, including at least a first section and a second section;
wherein each of said sections is comprised of a plurality of report data fields;
wherein said new digital emergency medical services report form is substantially the same as an existing paper emergency services report form used by said emergency response unit;
responding to a medical emergency incident of a patient by an emergency response unit;
generating by said electronic data processing unit a unique emergency medical services report number;
assigning by said electronic data processing unit said unique emergency medical services report number to said new digital emergency medical services report form for said patient;
wherein said unique emergency medical services report number is unique to said new digital emergency medical services report form;
wherein said unique emergency medical services report number is a sequence of alphanumeric characters that is a combination of a plurality of identification codes;
wherein said plurality of identification codes are selected from the group consisting of: a provider code; a numeric date code; a year code; a unit number; and a unit code;
inputting a plurality of incident data into said plurality of report data fields by said emergency response unit comprising the steps of: (a) selecting said first section to input said plurality of incident data; (b) generating and displaying by said electronic data processing unit a first section form, wherein said first section form displays a plurality of first section report data fields, and wherein said plurality of first section report data fields correspond with said plurality of report data fields of said first section; (c) inputting said plurality of incident data into said plurality of first section report data fields by said emergency response unit; (d) populating, by said electronic data processing unit, said incident data inputted into said first section form into said plurality report data fields of said selected first section; (e) selecting said second section to input said plurality of incident data; (f) generating and displaying by said electronic data processing unit a second section form, wherein said second section form displays a plurality of second section report data fields, and wherein said plurality of second section report data fields correspond with said plurality of report data fields of said second section; (g) inputting said plurality of incident data into said plurality of second section report data fields by said emergency response unit; (h) populating, by said electronic data processing unit, said incident data inputted into said second section form into said plurality report data fields of said selected second section;
wherein said plurality of sections are comprised of the following sections: Incident Information; Transportation, Patient Assessment; Patient Info; GCS/mLAPSS; Special Circumstances; Comments; Complaints; Physical Characteristics; Vital Signs; Therapies; ALS Procedures; Team Member IDs; Cardiac Arrest; and Reassessment after Therapies;
wherein said plurality of sections is further comprised of a signature section;
selecting said signature section to input one or more signatures of one or more members of said emergency response unit that completed said new digital emergency medical services report form;
digitally inputting said one or more signatures of said one or more members of said emergency response unit that completed said new digital emergency medical services report form;
wherein said new digital emergency medical services report form is further comprised of a navigation menu;
wherein said navigation menu is displayed at a top portion of said new digital emergency medical services report form;
providing one or more supplemental digital emergency medical services report forms;
wherein said one or more supplemental digital emergency medical services report forms are accessed through said navigation menu;
wherein said one or more supplemental digital emergency medical services report forms are selected from the group consisting of: a digital supplemental continuation form; a digital medicare form; and a digital against medical advice form;
wherein said one or more supplemental digital emergency medical services report forms each have a plurality of supplemental data fields;
inputting a plurality of supplemental incident data into said plurality of supplemental data fields by said emergency response unit;
wherein said navigation menu is further comprised of options selected from the group consisting of: information; supplemental forms; transmit; and finish report;
selecting by said emergency response unit said information option;
displaying by said electronic data processing unit an information screen;
wherein said information screen provides a plurality of links to information selected from the group consisting of: medication; treatment guidelines; medical control guidelines; and municipal policies;
completing said new digital emergency medical services report form; and
transmitting said completed emergency medical services report form to one or more medical facilities that receive said patient after said patient is released by said emergency response unit.

18. A device for filling out a digital emergency medical services report form, comprising:
an electronic processing unit;
wherein said electronic processing unit has a display;
wherein said electronic processing unit is portable;
wherein said electronic processing unit displays a digital emergency medical services report form;
wherein said digital emergency medical services report form is comprised of a plurality of sections, including at least a first section and a second section;
wherein each of said sections is comprised of a plurality of report data fields;
wherein said digital emergency medical services report form is substantially identical to an existing paper emergency services report form used by an emergency response unit;
wherein said emergency response unit responds to a medical emergency incident of a patient;
wherein said emergency response unit inputs a plurality of incident data into said plurality of report data fields.

19. The device for filling out a digital emergency medical services report form of claim 18, wherein said electronic processing unit has a touch screen;
wherein said plurality of incident data is input into said plurality of report data fields through said touch screen;
wherein said electronic data processing unit generates a unique emergency medical services report number;
wherein said electronic data processing unit assigns said unique emergency medical services report number to said digital emergency medical services report form for said patient;
wherein said unique emergency medical services report number is unique to said new digital emergency medical services report form;
wherein said unique emergency medical services report number is a sequence of alphanumeric characters that is a combination of a plurality of identification codes;
wherein said plurality of identification codes are selected from the group consisting of: a provider code; a numeric date code; a year code; a unit number; and a unit code.

20. The device for filling out a digital emergency medical services report form of claim 19, further comprising:
wherein said plurality of sections is further comprised of a signature section;
wherein one or more members of said emergency response unit uses said touch screen to input one or more signatures into said signature section;
wherein said emergency response unit completes said digital emergency medical services report form; and
wherein said electronic data processing unit transmits said completed emergency medical services report form to one or more medical facilities that receive said patient after said patient is released by said emergency response unit.
